(19) United States
(12) Patent Application Publication
(10) Pub. No.: US 2002/0013716 A1
(43) Pub. Date: Jan. 31, 2002

(54) Network based integrated system of care

(76) Inventors: Michael H. Dunham, Madison, WI (US); William G. Camperlino, Madison, WI (US); Jodee Grailer, Monona, WI (US)

Correspondence Address: MICHAEL BEST & FRIEDRICH, LLP, 100 E WISCONSIN AVENUE, MILWAUKEE, WI, 53202, US

(21) Appl. No.: 09/909,242

(22) Filed: Jul. 19, 2001

Related U.S. Application Data
(60) Provisional application No. 60/219,296, filed on Jul. 19, 2000.

(51) Int. Cl. G06F 17/60

(52) U.S. Cl. 705/2

(57) ABSTRACT

The invention provides methods and systems that manage the provision of care by driving care providers to follow the wraparound process in the provision of care. The methods and systems include input of data into a database and subsequent use of the input data to fill data fields that the care providers utilizes in development of documents related to the provision of care. An authorization feature ensures that the input data is appropriate and a lock-out feature prohibits input of data for subsequent tasks until previous tasks are considered complete. The invention also includes report generation and financial tracking of the care providing process. The invention is expandable to incorporate all functions an organization may perform in the provision of care.

### BACKGROUND OF THE INVENTION

The present invention relates to methods and systems to manage the provision of care. More particularly, the present invention relates to network based integrated systems of care that concentrate the best resources available to the client to assure the most effective outcome for those in need of care.

Management systems for individualized care often present challenges to care providers in administering and monitoring the care that is provided. The systems must manage collection of data, assessment of needs, provision of services to address identified needs, interaction with various care providers, insurance providers, and other organizations, facilitation of payments for the treatments that have been provided, and anything else required to provide care.

Previous efforts to manage individualized care include manual systems that incorporate creation and review of paper files that record appropriate information. Such efforts are naturally labor intensive and inefficient. Efforts have also been made to standardize data collection forms, descriptions of diagnoses, and description of treatments or problem solving techniques, in order to more efficiently collect, evaluate, and process relevant data. However, because the care is individualized, standardization of forms sometimes limits the ability of care providers to effectively evaluate and analyze the individual. Other efforts have been made to automate the process, but those efforts, along with all of the other non-integrated systems of care typically create situations where “the right hand does not know what the left hand is doing.” Generally, information is not readily accessible by all of the individuals involved in the process that need access, thus resulting in duplication of effort, inefficient management of data, increased costs of providing services, and reduced ability to serve the individual in need of care.

Due to the escalating complexity and cost of providing individualized care, there is an ever increasing emphasis on increasing the efficiency of managing the care providing process. The process of providing care to an individual usually begins with referral of the individual to a care provider, and continues through evaluation of the individual, diagnosis, therapeutic or problem solving selection, resource selection, treatment, and follow-up. The overall process for each individual is governed by a plan of care that lays out the prescribed course of action in treating the individual. The plan of care typically involves constant administration and monitoring to ensure the individual is progressing throughout the process. The plan of care often calls for more than one care provider to provide care to the individual. Although someone is in charge of the overall process for each individual, the lack of an effective management tool often results in these numerous care providers acting as single entities instead of members of a team, thereby reducing the effectiveness of the overall plan of care. Care providers acting on their own also increase costs of the process by providing services that are duplicative or counter to what the plan of care prescribes. Even though in most cases authorization to perform a service is technically required before the services are performed, actual practice dictates a process where services are provided first, and then approved and paid for later.

The collection and maintenance of all of the data necessary throughout the process creates a large burden for the care providers, which burden can reduce the amount of time the care provider has to focus on delivering care, thereby adversely affecting the quality of care that is given to the individual. It is therefore desirable that a system be provided to administer, monitor, and report data related to a plan of care in an efficient and accurate manner.

### SUMMARY OF THE INVENTION

Accordingly, the invention provides a network based integrated system of managing a plan of care for one or more individuals. The system is based upon an approach for providing care that creates and organizes the resources and services needed to allow an individual in need of care to live in the most normalized and least restrictive environment possible by wrapping services around the individual and the individual's support structure. This approach is commonly referred to as the wraparound process. The wraparound process determines what unique needs and strengths each individual and family support structure has, and then creates a plan of care tailored to those needs and strengths. It is widely viewed that this holistic, strength based approach, supports both the individual and family support structure while maintaining the organization needed for successful execution of the plan of care.

The network based implementation of the wraparound process embodying the invention typically includes a support team that is made up of the four to ten people who know the individual best and are willing to assist the individual in the process. The support team generally includes the individual, members of the family support structure, and other members of the community with whom the individual is close. A combination of the support team and professional care providers makes up an overall team. Ideally, professional care providers make up no more than half of the overall team.

In one embodiment, the network based implementation of the wraparound process also includes the development of a plan of care. The plan of care is developed based on the unique strengths, values, norms and preferences of the support team and the individual's environment (i.e., community). The plan of care is generally focused on typical needs in life domain areas that all similarly situated persons (e.g., of like age, sex and culture) have. These life domains can be faith, family, community, friends, social, health, emotional, legal, cultural, and others. The plan of care should be a combination of informal resources (i.e., family and friends), existing or modified services, newly created services, and community resources. Collaboration among organizations and systems providing services or care for individuals is a good way to build effective services for those in need, especially those with serious and complex needs. Inclusion of all these people and factors in the planning process is extremely helpful in developing a plan of care that has increased acceptance by the members of the overall team and that is more likely to be effective in treating the individual.

There are typically many different care providers assigned to the overall team for an individual. It is important to keep the channels of communication open between all of the care providers and the members of the support team. As a plan of care is developed and implemented, outcome measures are identified by members of the overall team and the plan of care is often evaluated and revised to reflect those outcome measures.

Core principles upon which the wraparound process is based include: (1) the support team identifies the individual's strengths and needs, is responsible for helping the individual, and must be committed to work together to make the plan of care successful; (2) the individual is likely to be more successful at achieving independence in his/her own home and community; and (3) since each individual is unique, a customized plan of care can be developed that is responsive to the cultural needs of the particular support team. In essence, the wraparound process empowers families to work with systems in ways that are productive for the well being of the individual involved in the process.

The network based implementation of the wraparound process is best explained as a series of events that take place in order to accomplish identified outcomes. The first step in the process is the referral stage. An individual or family is identified as needing the wraparound process and is referred to an intake person. Relevant contextual information regarding the family is collected. A coordinator is assigned to meet with the family to perform an assessment of the family including identifying various strengths and needs of the family. The family identifies members of the family and friends that know the individual best. The family also identifies what care providers have been working with the individual in the past. The coordinator notifies the appropriate service entities that they may be needed to provide certain care to the particular individual.

The second step of the process is the enrollment stage. Once all of the preliminary information is gathered, the family members and friends are prepared for a team meeting to bring all of the parties together. Possible care providers are also prepared by reviewing the preliminary information. At the initial team meeting, a plan of care is formulated by the team members by re-assessing assets and needs across the applicable life domains. A crisis plan for home, school, hospital, legal, community, etc., intervention is also typically formulated. The supports and services that utilize the assets and meet the identified needs of the individual and family are selected. The plan of care becomes the blueprint for a coordinated, integrated plan between systems and natural supports working with the family. Information is shared between the team members that may be helpful to each other in terms of carrying out the plan of care. Responsibilities and expectations are communicated to the members of the team.

The third step of the process is the implementation stage. The team meets regularly to make sure the plan of care is working or to adjust the plan as needed. The monitoring of the plan of care is an important aspect of the wraparound process to ensure the process is moving forward in an efficient manner. Evaluations are typically conducted during this stage to determine which actions are effective and which actions are ineffective. Contact between the team members is encouraged. As the individual becomes more stabilized, the responsibilities of the care providers are transferred to the family and community supports. The objective is to transfer all services to family and community supports as the individual needs fewer and fewer formal services.

The fourth and final step in the process is the stabilization or disenrollment stage. During this stage a complete review of the entire process is performed. This stage typically begins once the individual does not require any further care to be provided by the professional care givers. A new plan of care is typically provided for the family and community supports to continue providing various services. Arrangements are made such that if services from a care provider are needed in the future, such services may be continued. At this point in the process, the plan of care is viewed as being completed and the case is closed. The case can be reopened if future care providers are needed, but typically such a situation results in the process starting all over again.

The wraparound approach can be summed up as an approach that uses a consistent process which creates a partnership between the team members to support the individual in need, building on the individual strengths. The approach promotes the involvement of all the important people in each individuals life to work toward a common goal. The approach develops a clear, integrated plan, including a crisis plan, which is regularly reviewed and which includes accessing needed resources. The approach continuously collects information to keep improving outcomes for the individual and the family.

Notwithstanding the known benefits of the wraparound process, the art has not adequately responded to date with the introduction of a management system that efficiently implements the wraparound process. However, just as with other approaches to care management, implementation of the wraparound process suffers when an efficient management system is not available. The invention cures the problems of previous efforts of managing the care of individuals by providing a network based system that drives the system user through the wraparound process. The user is required to complete numerous tasks before subsequent tasks can be accessed. Effectively, the system acts as a watch dog to ensure the technical requirements of the system are actually followed in practice.

The integrated system of care interactively allows all members of the team to participate in the process. The enhanced communication and access to information allows each member of the team to better serve the individual in need of care. Advances in distributed technology such as the Internet allow users to log on to the system and input and obtain information about the clients from where ever they are. This ability permits information to be used in real-time, i.e., the information is available for use by all team members almost as soon as it is discovered. Security measures are utilized to ensure only those users with proper access see information that is sensitive in nature (i.e., therapist evaluations, individual information, etc.). The system can be administered and monitored by the team members at various stages of the plan of care, thereby permitting updating and modification of the plan of care on an as needed basis. Modification in this manner results in a more efficient plan of care which is thereby more cost-effective.

In one embodiment, the invention provides a method of managing the provision of care to a client including use of a software program to ensure adherence to a wraparound process. The method includes involvement of a support team made up of family members of the client, friends of the client, and other community members that know the client well to provide care to the client. The method includes inputting assessment data including strengths and needs of the client and of the support team into a database using an assessment data entry page, displaying the assessment data on a plan of care data entry page, and developing a plan of care by utilizing the plan of care data entry page as a framework for the plan of care.

In another embodiment the invention provides a method of managing the provision of care to a client including use of a software program to ensure adherence to a wraparound process. The method includes inputting data related to the provision of care to the client into a database using a first page, and inputting further data related to the provision of care to the client into the database using a second page. The software program prevents entry of the further data until the first page is authorized by at least one authorizing user.

In another embodiment the invention provides a method of developing a plan of care for a client including use of a software program to ensure adherence to a wraparound process. The method includes the involvement of a support team made up of family members of the client, friends of the client, and other community members that know the client well to provide care to the client. The method includes inputting assessment data including a defined objective for the client, strategies for achieving the defined objective, behaviors exhibited by the client, and strengths and needs of the client and of the support team into a database using an assessment data entry page, displaying the assessment data, including displaying each of the strategies for achieving the defined objective along with a list of the strengths and needs, on a plan of care data entry page, and developing a plan of care by utilizing the plan of care data entry page as a framework for the plan of care, the act of developing a plan of care including the acts of analyzing the strengths and needs listed, formulating a goal statement for each of the strategies for achieving the defined objected based on the analyzed strengths and needs, and inputting plan of care data based on the goal statements into the database using the plan of care data entry page.

In another embodiment the invention provides a network based integrated system of care that includes a computer and a software program on the computer that performs the method of the other embodiments of the invention.

As is apparent from the above, it is an advantage of the invention to provide network based integrated systems of care that concentrate the best resources available into assuring the most effective outcomes for clients in need of care. Other features and advantages of the invention will become apparent by consideration of the detailed description and accompanying drawings.

### BRIEF DESCRIPTION OF THE DRAWINGS

In the drawings:

FIG. 1 illustrates a network based integrated system of care according to one embodiment of the invention.

FIG. 2 illustrates a login page according to one embodiment of the invention.

FIG. 3 illustrates a change password page according to one embodiment of the invention.

FIG. 4 illustrates a main menu page according to one embodiment of the invention.

FIG. 5 illustrates a double signature feature according to one embodiment of the invention.

FIG. 6 illustrates a referral data entry page according to one embodiment of the invention.

FIG. 7 illustrates an eligibility determination data entry page according to one embodiment of the invention.

FIG. 8 illustrates an episode open data entry page according to one embodiment of the invention.

FIGS. illustrate 9A-9B a team members data entry page according to one embodiment of the invention.

FIG. 10 illustrates a diagnosis data entry page according to one embodiment of the invention.

FIGS. 11A-11D illustrate an assessment data entry page according to one embodiment of the invention.

FIGS. 12A-12C illustrate a crisis plan data entry page according to one embodiment of the invention.

FIGS. 13A-13E illustrate a plan of care data entry page according to one embodiment of the invention.

FIG. 14 illustrates a planned actions timeframe selection page according to one embodiment of the invention.

FIG. 15 illustrates an outcome measures data entry page according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

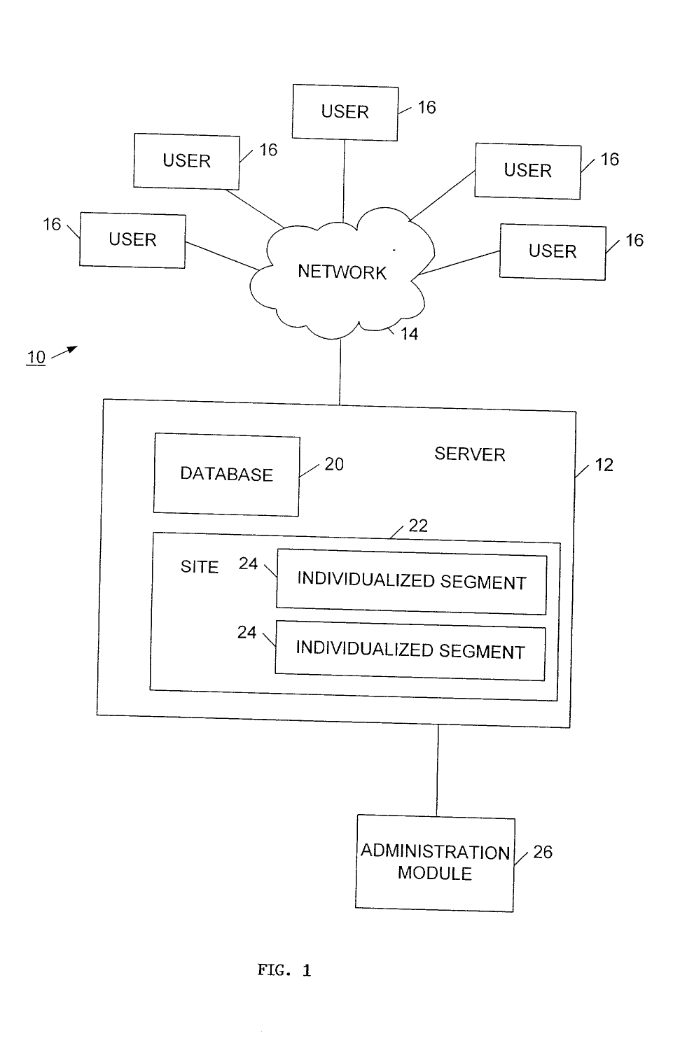

FIG. 1 illustrates a network based integrated system of care 10 according to one embodiment of the invention. The system 10 includes a server 12 connected to a network 14. A plurality of users 16 are also connected to the network 14. The server 12 includes a database 20 and a site 22 that is accessible by the users 16 of the system 10. The site 22 acts as a gateway for the users 16 to assist in the care providing process.

It should be understood that while the description discusses the users 16 as being connected to the network 14, the users 16 are not part of the physical layer of the system 10. Rather, the users 16 operate computers, terminals, or other hardware devices that are connected to the network 14. The terminals may include standard input and output devices such as a mouse, keyboard, printer, and display. Of course, the terminals could include a host of advanced and/or yet to be developed input and output devices such as voice recognition devices. The terminals or hardware devices may include an operating system, a browser, and communication software and hardware for communicating with the server 12 and each of the other terminals via the network 14. Preferably, the browser is a web based browser, such as a Microsoft Explorer browser or a Netscape Communicator browser, capable of displaying information formatted with a fixed set of tags, such as HTML or XML documents. In one embodiment, the network 14 is the Internet, thereby providing global communication and scale to the invention. However, the network 14 may be other types of networks, whether packet switching or not or based on Internet protocols or not. Further, although not shown, the system 10 can be scaled to include any number of users and associated terminals.

In another embodiment, the system 10 is non-network based. The system 10 can be software based and contained on a single workstation that is accessible by all users. Alternatively, a software based embodiment can be utilized to perform all the administrative and management type responsibilities associated with the provision of care and hard copy reports can be delivered to the team members for review.

The framework of the system 10 is based on the wraparound process. The overriding principle of the wraparound process is to prevent the placement of an individual (i.e., client) that is in need of care into a long-term institutional setting. The wraparound philosophy involves the people closest to the individual and the care providers in the local community in the plan of care for the individual. The idea is that, if an individual is removed from the environment that the individual is accustomed to, and returned back to that environment sometime in the future, the individual has a harder time adjusting to the surroundings as compared to if the individual never left that environment.

The system 10 is useful for many different applications. For example, the system 10 can be used for child welfare systems, allowing families to participate in the decision making about the care and safety of their children. The system 10 can be used by the juvenile justice system for restorative justice of juveniles, including competency development, accountability and community safety. The system 10 can be used for mental health systems to increase family centered services in the home and community. The system 10 can be used by school systems to develop policies and procedures for family participation in individualized educational plans for children. The system 10 can be used for elderly care systems to coordinate, among other things, home health care and assistance for tasks that need to be completed around the elderly individual's home. The system 10 is generally useful for any care providing application that incorporates multiple care providers, especially those applications based on the wrap around process.

The system 10 incorporates clinical, administrative, and financial functions of the care providing process. Clinicians, supervisors, care providers, and family members are provided with the opportunity to combine and coordinate all information, resources, and services for a client into an organized referral, assessment, and treatment system that provides client-centered care planning and individualized services while providing management tools that ensure fiscal responsibility.

Participating Organizations

The system 10 is primarily designed for organizations that provide services to individuals in need of care. In one embodiment, the site 22 includes individualized segments 24 of the site 22 for each organization participating in the system 10. The individualized segments 24 take into consideration all of the special needs and desires that the participating organization has for the system 10. Examples of participating organizations include public organizations such as county or state agencies, private not-for-profit organizations, private for-profit organizations, and any other organization that desires to concentrate the best resources available into assuring the most effective outcomes for clients in need of care.

In order to access and utilize the site 22, participating organizations obtain a license from a system provider. A system administrator associated with the system provider works with the participating organization to develop the participating organization's individualized segment 24. Although the framework for the individualized segments 24 is consistently based upon the wraparound process, each participating organization may have different needs related to the type of care being provided, the types of organizations and/or providers that the participating organization is working with, the type of data that is being collected, applicability of state and/or county rules and regulations, etc. In order to set up the individualized segment 24 of the site 22, the system administrator accesses the site 22 on the server 12 via an administration module 26 connected to the server 12.

Setting up the system 10 to include a new participating organization typically includes processes such as entering information about the participating organization and entering information about the contractual terms of the license. The system administrator inputs information such as the participating organization's name, code, address, phone number, alternate phone number, bank name, bank routing number, bank account number, and any other information needed to contact and bill the participating organization. All of this information is input in accordance with the techniques discussed below.

The system administrator works with a site administrator associated with the participating organization to develop all of the pages for the individualized segment 24. The actual design and/or format of the pages is not critical to the invention, the pages need only to allow the user to perform the functions that they so desire. The pages may be designed in accordance with generally known web development techniques and may include specific formats that the participating organization utilizes. Each participating organization has its own individualized segment 24 that may include a larger or a smaller number of pages than the embodiment discussed herein. The system 10 is designed to accommodate expansion of the site 22 to include any and all functions that a participating organization performs. Typically, the more functions the participating organization utilizes the system 10 for, the more effective the participating organization is capable of being at managing the provision of care to the individual. The functions that are explained herein are illustrative of only some of the functions that the system 10 is capable of performing.

Although the system administrator is in charge of initial development of the individualized segment 24, the site administrator takes over much of the responsibility of developing and maintaining the individualized segment 24 once they are trained in the operation of the system 10. The system provider supplies documentation and continued support to assist the site administrator in carrying out their duties. Since the system administrator and/or the site administrator can perform many of the same duties, the generic term administrator shall be used herein to describe the person performing such duties.

Another process that must typically be completed to add a new participating organization to the system 10 is entering information about the users 16. The users 16 include persons such as providers that the participating organization works with to provide care, employees of the participating organization (i.e., coordinators, supervisors, backup supervisors, intake persons, etc.) that assist in the care providing process, other team members such as family members and community members, and anyone else involved in the care providing process. Information such as the user's name, login name, initial password, and contact information are input into the system 10 in accordance with the techniques discussed below. The administrator also establishes what the user 16 does and does not have access to on the individualized segment 24 by setting an access code for each page or module of the site 22 to “no access,” “read only access,” or “read/write access.”

Additional processes may need to be completed before a participating organization is able to utilize the individualized segment 24. Typically, the development of the individualized segment 24 includes the set-up of the pages and then the entering of different types of information that are utilized on the pages. Any change in the content of information that is included in the system 10 can be updated as discussed below.

Accessing the Site

Each user 16 that is set up to use the system 10 has their own secure account for interaction with the site 22 and at least one individualized segment 24. A user 16 typically only has access to one individualized segment 24, however, the user 16 may have access to more than one individualized segment 24 if the user 16 is associated with more than one participating organization.

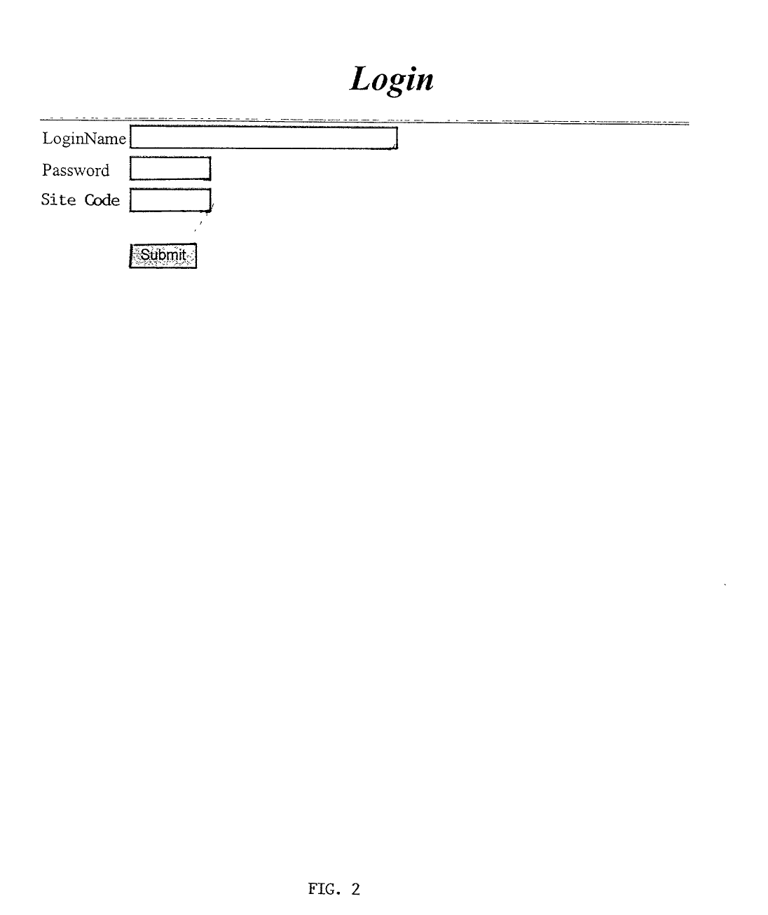

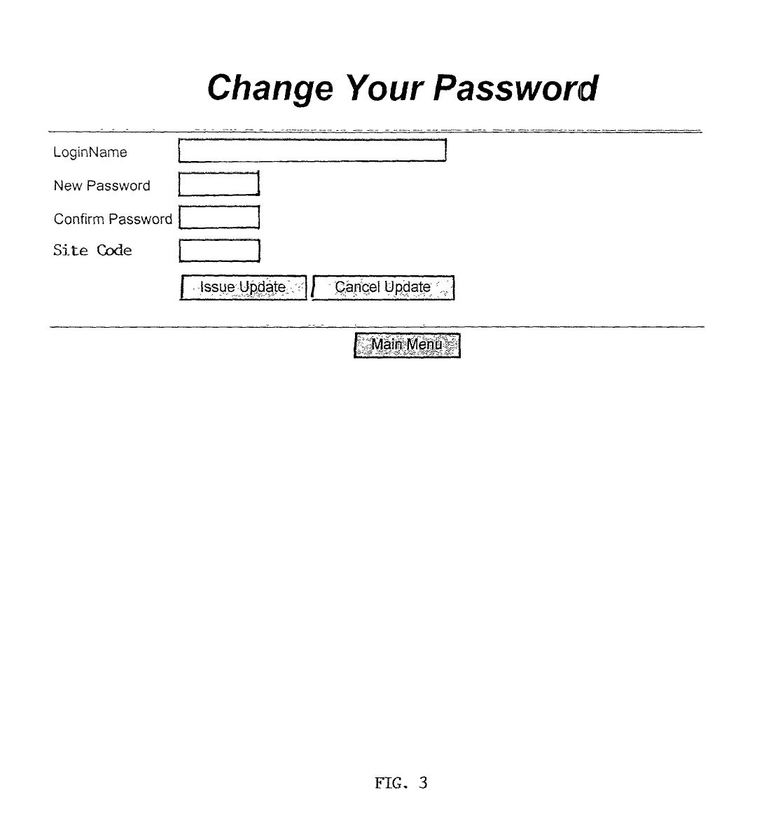

To open the site 22, the user 16 first connects to the network 14 using a browser and then enters the site address in the address field of the browser. A “login” page of the site 22, as illustrated in FIG. 2, is displayed if the user correctly entered the site address. The login page includes fields for entering the user's login name, password, and a site code for the individualized segment 24 the user would like to access. The user's login name and password are assigned to them by the administrator. The site code for the individualized segment 24 is set by the system administrator when the individualized segment 24 is setup. For security reasons, upon first logging into the system 10, the user is asked to change their password. A “change password” page, as illustrated in FIG. 3, appears and the user 16 sets a new individualized password. Passwords for the system 10 are also set to expire within certain time limits (as set by the administrator). The user 16 is prompted to change their password when the time limit has elapsed. The user 16 may also change their password at anytime they desire by selecting the change password page and entering and verifying a new password.

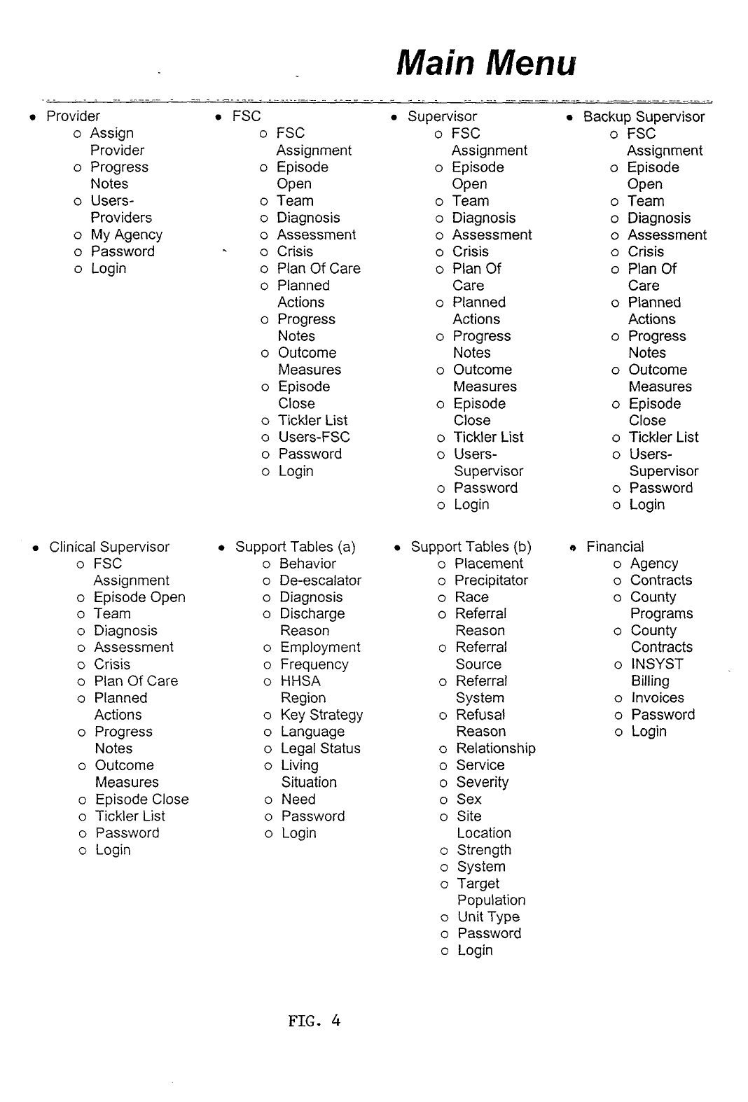

Once logged onto the site 22, a customized “main menu” page appears. One embodiment of the main menu page is illustrated in FIG. 4. The main menu page links the user 16 to all parts of the site 22 that the accepted login name, password, and site code give the user 16 access to. In one embodiment, the main page is formatted to include a plurality of head titles, each head title representing a plurality of function or page options. The head titles may be arranged by user and/or function. For example, a main page may include head titles such as supervisor, coordinator, family/community support team, data entry, financial, reports, system configuration, etc. Under each representative head title are links to all functions or pages related to that head title. For instance, the coordinator head title would include all pages that the coordinator has access to. A user 16 may have access to only some of the function options under only one of the head titles or the user 16 may have access to all function options under all head titles, or any number in between, based on the user's 16 access. Considerations such as confidentiality of information and importance of information dissemination are evaluated when the breath of access for a particular user is being determined. Some examples of function options that are typically included in an individualized segment 24 include functions such as referral, eligibility determination, episode open, diagnosis, assessment, crisis plan, plan of care, planned actions, progress notes, outcome measures, report generation, users, login, tickler list, password, etc.

Site Operation

The system 10 design drives the user 16 to follow the wraparound process of providing care. Information regarding the strengths and needs of the individual and the individual's support team are provided to the user 16 when the user 16 is making decisions concerning the provision of care to the individual. Additionally, the users 16 are required to complete numerous tasks before subsequent tasks can be accessed. The system 10 effectively acts as a watch dog to ensure the technical requirements of the process are actually followed in practice.

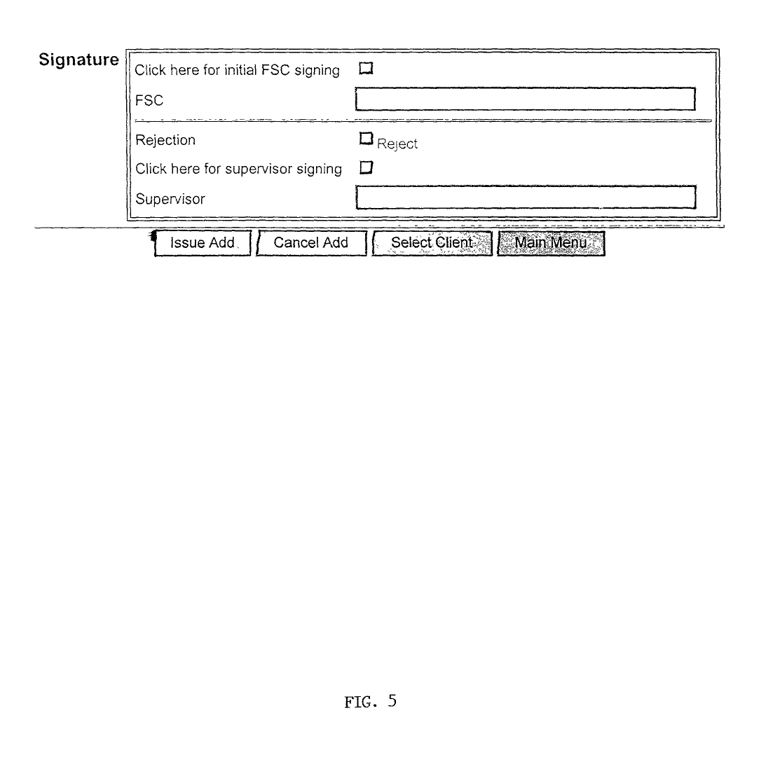

A “double signature authorization” feature, as illustrated in FIG. 5, is used in the system 10 to make sure that information entered is representative of the participating organization's overall goal of providing care. First, the double signature authorization includes a sign-off by the user preparing the information. Generally, once the user has completed entering the information on a page and it is believed that the page properly represents the desired results for the representative step of the care providing process, the user selects their name from a drop-down menu and fills in the date thereby signing-off. Once the preparing user has signed-off, a higher authority, generally the supervisor, has an action item generated on their tickler list (discussed below) that instructs them to review and accept or reject the proposed page. After the supervisor has reviewed the page, the supervisor can then authorize the page by selecting their name from a drop-down menu and filling in the date. In one embodiment, the dates are automatically filled in when a name is selected. If the supervisor wishes to reject the page, a rejection box is checked and the same name and date information is noted. The supervisor may include a narrative comment regarding reason(s) for the rejection if it is desired. In one embodiment, if the page is rejected an action item is placed on the original preparing user's tickler list to recreate the page for further evaluation. In another embodiment, any type of authorization data can be utilized to authorize a completed page to all for execution of subsequent tasks in the care providing process. Authorization data can include checking off a box, entering an authorizing user's name, entering the date the authorization was made, etc.

Another feature of the system 10 is a “tickler list.” The tickler list acts as a docketing system for the users 16 so that each user 16 properly performs their duties in the time allocated for performance of such duties. The tickler list provides each user with a listing of action items that are overdue, due the current day, and due in the near future. This list can help the user 16 determine priorities and monitor whether work is complete. A supervisor typically either has access to the subordinate users' tickler list, or such information is indicated on the supervisor's tickler list. This access allows each level of management to make sure that individuals whom they are responsible for are finishing their tasks expediently. The tickler list may include generation of reminders and/or reports that indicate action items that need to be completed and/or action items that are overdue.

The pages of the site 22 can generally be categorized as either selection pages or data entry pages. The selection pages allow the users 16 to select a specific client or timeframe for which to view, enter, and/or update information. The data entry pages allow the users 16 to enter and/or update information specific to the chosen client or timeframe. The user 16 accesses all function options from the main page. For example, if a coordinator wishes to access the assessment function, the coordinator clicks on assessment under the coordinator head title. A list of all of the clients the coordinator is responsible is displayed. From this page the coordinator selects which client an assessment function is to be performed for. Next, a page is displayed that indicates any assessments that have already been created. On this page the coordinator can either select to view an assessment, create an assessment, or update an assessment. The coordinator's ability to perform these different tasks depends on what has been previously completed. If creation of a new assessment is selected, an assessment data entry page is displayed and the coordinator can enter assessment information.

The system 10 includes navigation tools that allow the user 16 to efficiently move through the site 22. Tools are available that allow the user 16 to sort and/or select information by the categories that are listed for each set of information (e.g., client name, date of birth, social security number, referral date, supervisor, etc.). These sort and selection tools allow the users 16 to find the client they are looking for quickly, especially when the participating organization has a large number of clients and the user 16 only has limited information regarding the client that they are searching for. As the user 16 navigates deeper into a function, action buttons are available to move throughout the function (e.g., back to select client, select assessment, main menu, etc.). The system 10 also includes other generally available web navigation tools such as page flippers (e.g., when multiple pages are used to display information, the use of forward or backward one page, forward to the end, back to the beginning), and save and/or cancel action buttons.

A “store locally” feature allows the user 16 to store data that is being entered on a data entry page locally on their own terminal before uploading the finalized version of the data to the server 12. When information is stored locally the data fields into which data was entered are reset and the data appears in the table corresponding to the entered data (i.e., the data appears as if it is part of the system 10). This feature allows the user 16 to view the information they wish to enter before it becomes part of the system 10 to make sure it is correct and in accordance with the desired input for the respective step of the process. If the user 16 does not wish to upload the information stored locally, a “delete locally” feature allows the user 16 to remove such information. If the user 16 does wish to upload the information, the user 16 simply selects save.

The site 22 utilizes information entered once into the system 10 to fill data fields on pages requiring such data that are subsequently generated. This automatic importation of appropriate data assists in the driving function of the system 10. By providing the user 16 with all information related to, among other things, the strengths and needs of the client, the user is forced to observe this information when making determinations of what information to enter for steps of the process. The importation of data also reduces the administrative burden placed on care providers in managing the provision of care. Information generally only needs to be entered once and is then used throughout the system 10 as is necessary. Much of the necessary information is entered when the individualized segment 24 of the site 22 is setup and is then available through use of drop-down menus that include all possible fields that are entered in the system 10. If this information becomes out of date or needs updating, the administrator can update support tables that store such information and then the users 16 have access to the new, up-to-date information.

The representative pages illustrated in the figures do not demonstrate the automatic importation of information as utilized by the invention. All information has been removed and therefore, the pages are only illustrative of one embodiment of the structure the pages may have.

Using the System

The system 10 can be used in many different ways to perform numerous tasks related to the provision of care. The individualized segment 24 of the site 22 is modifiable to include as many or as few functions of the system 10 as the participating organization wants it to include. Following is a discussion of one example of using the site 22 to manage the provision of care starting with the referral of an individual into the system 10 and continuing to stabilization of the individual.

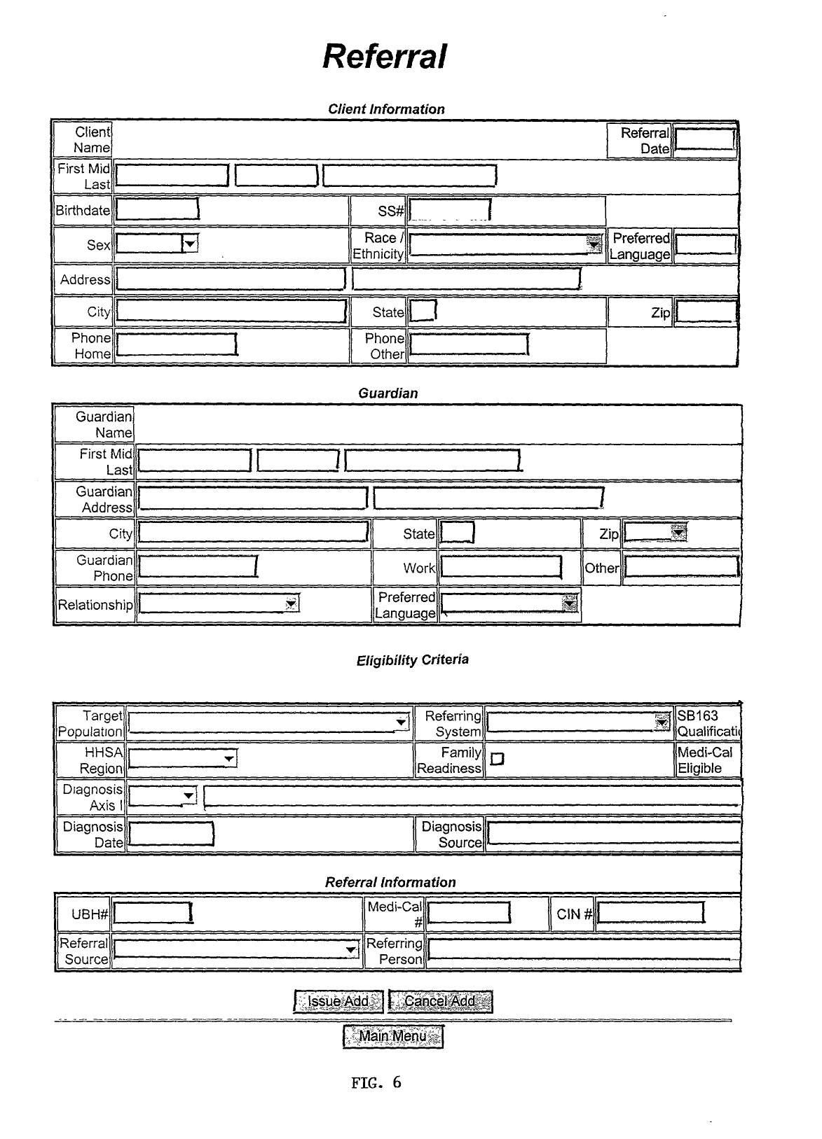

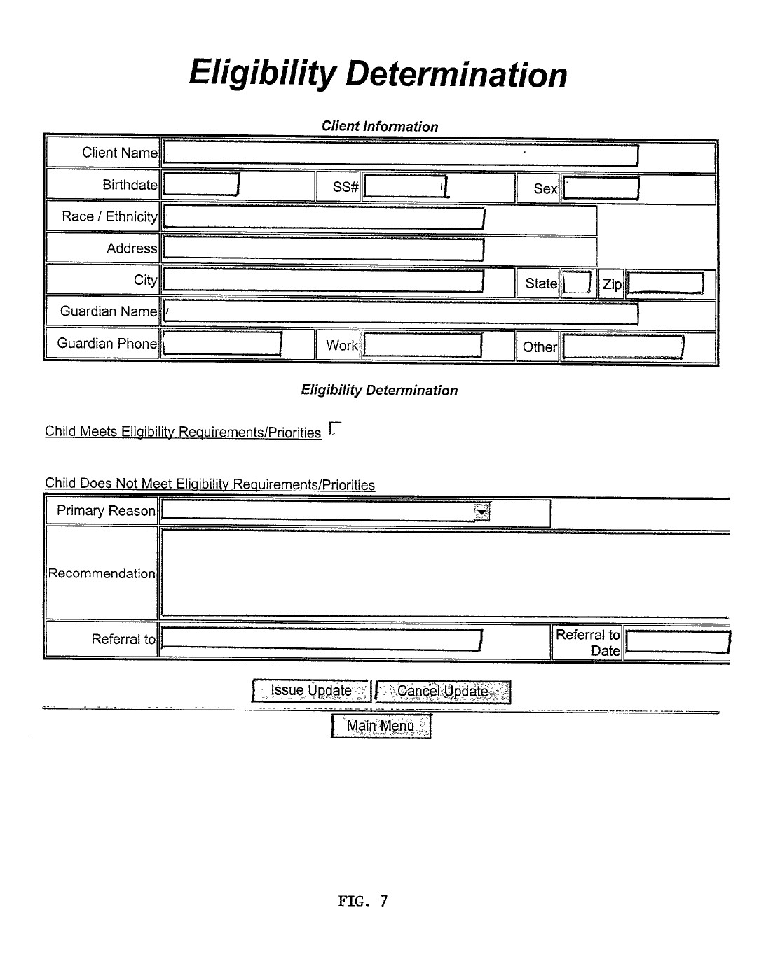

When an individual is identified as a candidate for participation in the system 10, the individual is referred to a participating organization that utilizes the system 10 to assist in the provision of care. An intake person associated with the organization obtains relevant contextual information regarding the candidate and enters the referral data into the system 10. The intake person accesses the site 22 and enters candidate information, guardian information, eligibility criteria, and referral information using a “referral” data entry page, as illustrated in FIG. 6.

After the referral data is entered, an eligibility determination of the candidate needs to be made. An action item is generated on the supervisor's tickler list to complete the eligibility determination for the candidate within the time specified by the system 10. The supervisor utilizes an “eligibility determination” data entry page, as illustrated in FIG. 7, that includes a client information section and an eligibility determination section when making the eligibility determination. The client information section of the eligibility determination entry page includes much of the information that was entered on the referral data entry page. This information is automatically imported into the client information section and cannot be edited on the eligibility determination data entry page. If the information is determined to be incorrect and therefore needs updating, the referral data entry page can be used to update the referral data. Under the eligibility determination section, data can be entered under a “candidate meets eligibility requirements” option or under a “candidate does not meet eligibility requirements” option. If the candidate meets eligibility requirements, the name of the supervisor that made the determination is selected from a drop-down list and the date of the determination is entered. If the candidate does not meet the eligibility requirements, a reason why the candidate does not meet the requirements is selected from a drop down list, a narrative recommendation for the candidate can be made, a referral to a different organization can be made, and the date the referral was denied is entered. If the candidate is not eligible for participation in the system 10, the candidate's profile reflects such status and further action on that profile is not permitted (i.e., a profile must reflect that an individual is eligible for participation in the system before subsequent functions can be accessed).

When a candidate is deemed eligible for participation in the system 10, the candidate becomes a client of the participating organization and the supervisor needs to being development of the client's team. If the supervisor does not perform this duty immediately after making the eligibility determination, a representative action item is generated on the supervisor's tickler list. Typically, the supervisor only assigns a coordinator and a backup supervisor to the client. These team members are selected from drop-down menus that include all available coordinators and back-up supervisors at the participating agency. This information is all entered when the individualized segment 24 was setup. Generally, the supervisor has access to review current case loads of the available coordinators and back-up supervisors to assist in determining who most effectively can serve the client. When a client is added to a team member's case load, the client's name and information are imported into the respective team member's client list.

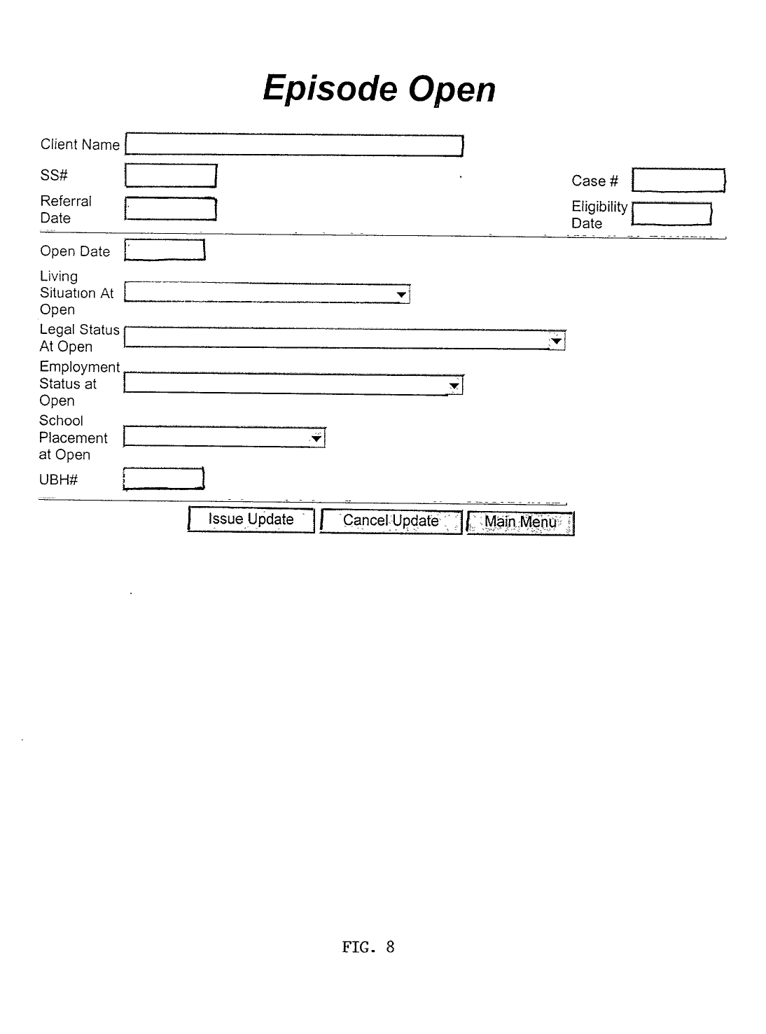

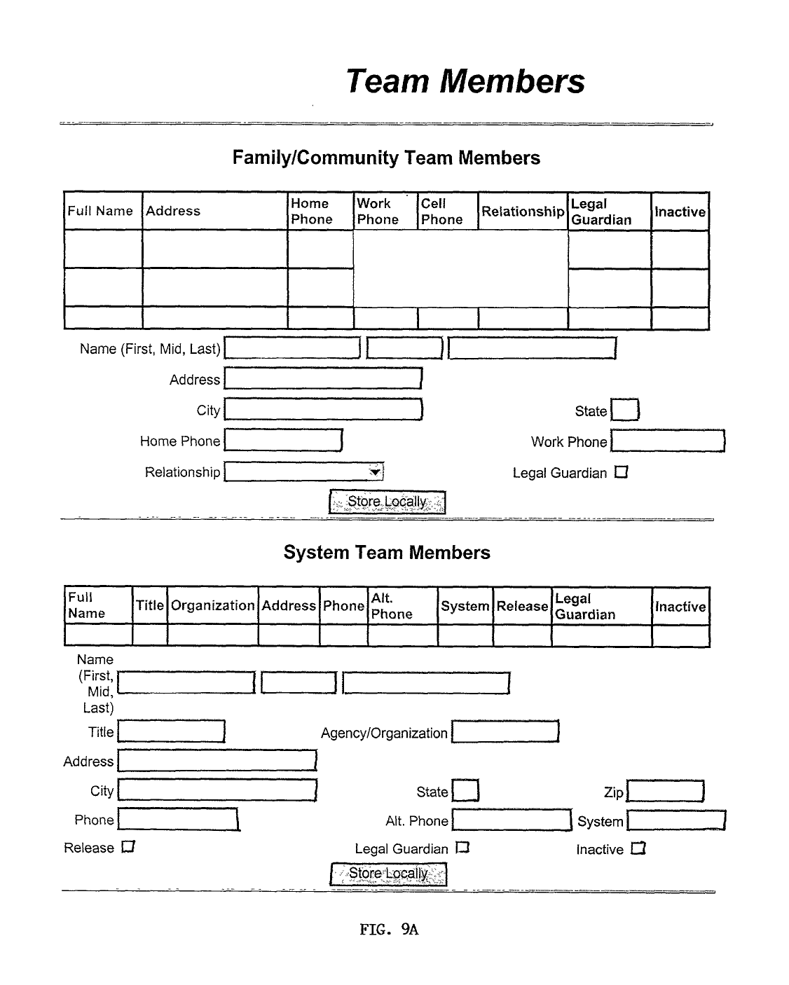

After a coordinator is assigned to a client, a number of action items are added to the coordinator's tickler list including an action item to open an episode for the client. An “episode open” data entry page, as illustrated in FIG. 8, is used to essentially enroll the client into the system 10. A case number and a start or open date are assigned to the client. The start date can be used to base time frames off for subsequent functions as defined in the system 10 (e.g., an assessment of the client should occur within fifteen days of the open date). Additional information about the client is selected from drop-down menus including their current living situation, legal status, employment status, and school placement. Completion of the episode open data entry page allows the team members to proceed to the next steps of the process.

Another action item of the coordinator's tickler list is the development of the rest of the team. The coordinator needs to determine what family members, friends, community members, and care providers are part of the client's overall team. A “team member” data entry page, as illustrated in FIGS. 9A and 9B, displays all team members currently listed for the client under three categories: (1) family/community team members, (2) service team members, and (3) system team members. Information about each team member includes name, contact information, and relationship to client. The coordinator can add additional team members or inactivate team members as needed using the team member data entry page. When a team member is assigned to a client, that client is added to the team member's client list thereby allowing the team member at least minimum access to information about the client. The administrator enters the team member into the system 10 and instructs them on how to access the site 22. Information previously entered including information about the client's guardian(s) is imported into the team member data entry page. The coordinator typically needs to enter information about the remaining family/community team members, but can select service team members and system team members from drop-down menus. Information about these individuals is already in the system 10.

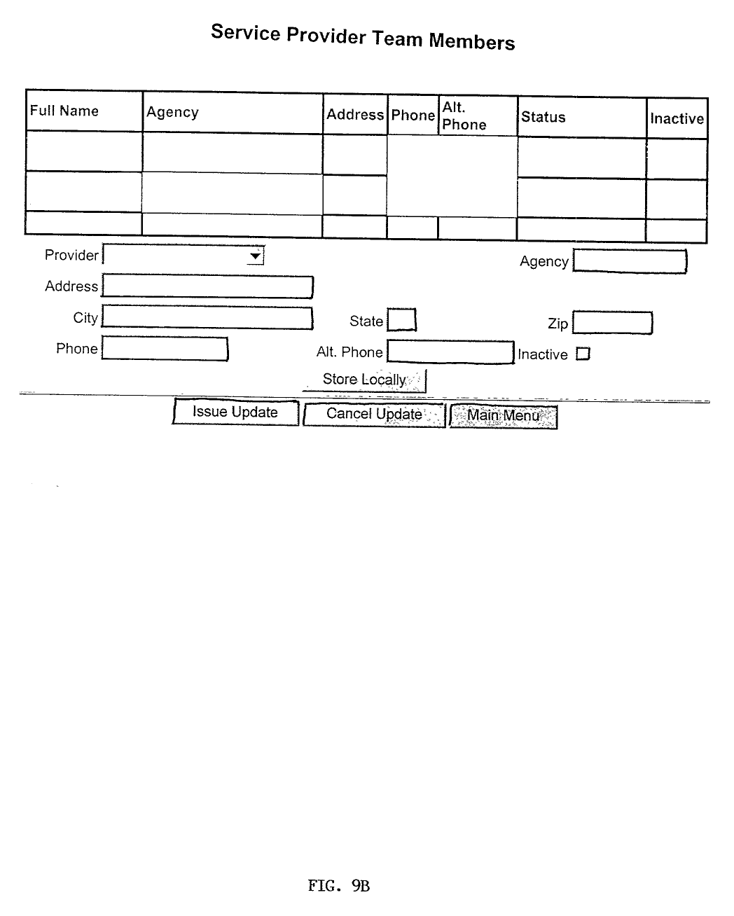

A “diagnosis” data entry page, as illustrated in FIG. 10, is used to input information regarding the client's current state. Information relating to axis I, axis II, axis III, axis IV, and axis V is selectable from drop-down menus that include most, if not all, possible diagnoses (this information is included in the support tables that may be provided directly from the system provider). Narrative notes regarding the diagnosis can also be entered. The first time a diagnosis is prepared, all applicable information already stored in the system 10 is imported into the diagnosis data entry page. This information can be edited if required. During each subsequent diagnosis, information from the most recent diagnosis is displayed for editing. The diagnosis data entry page requires double sign-off authorization before it is considered to be complete. The coordinator signs the page when they complete the diagnosis thereby alerting the supervisor (i.e., action item on tickler list) that they need to review the diagnosis and either approve or reject it.

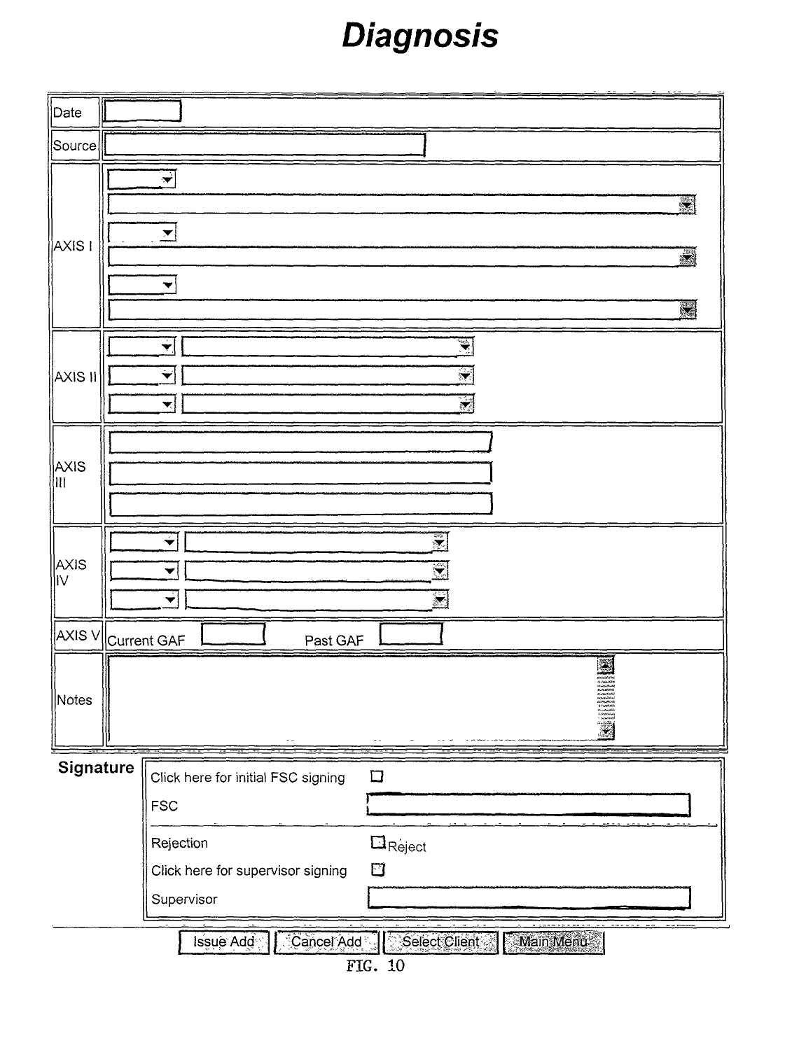

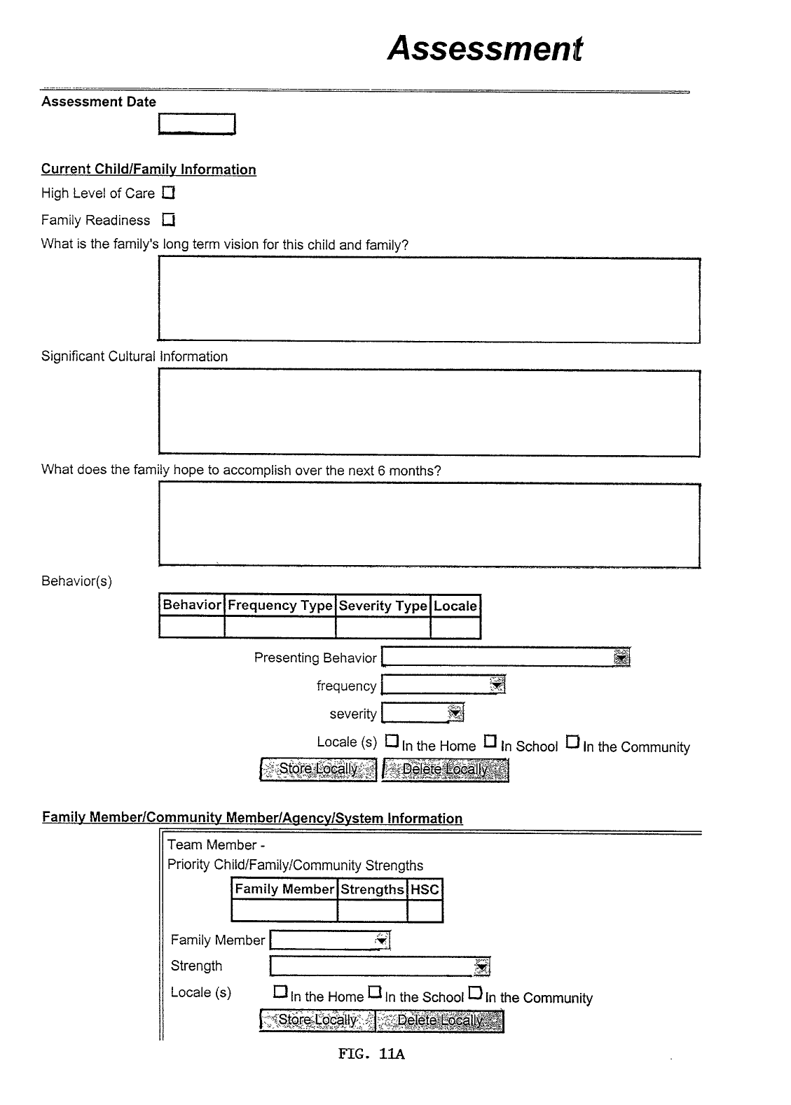

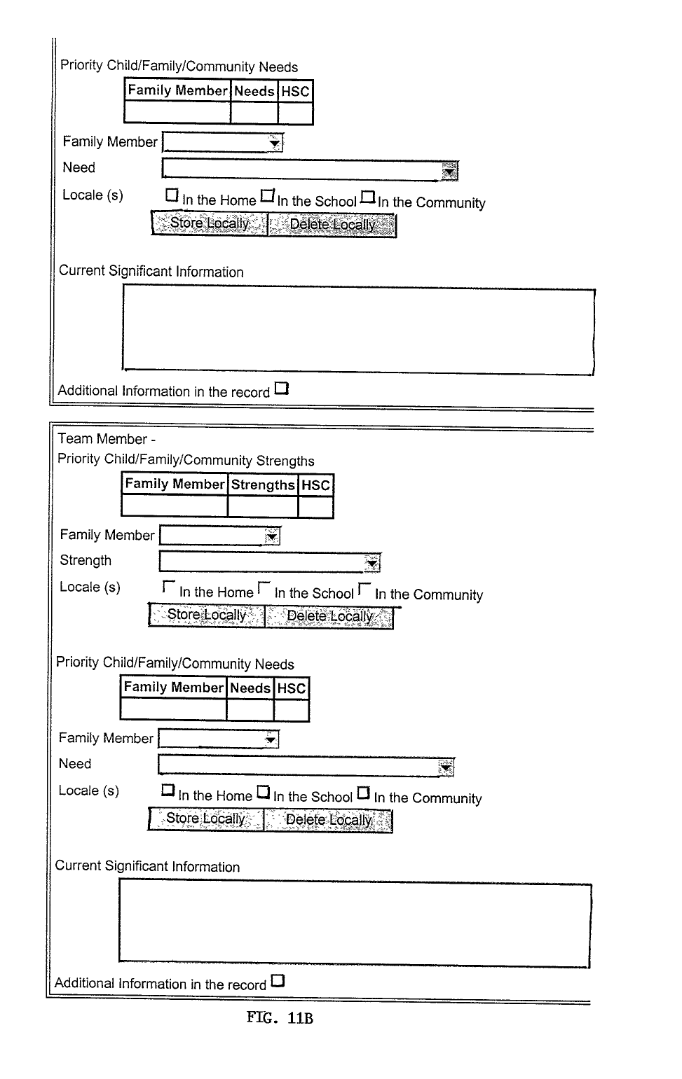

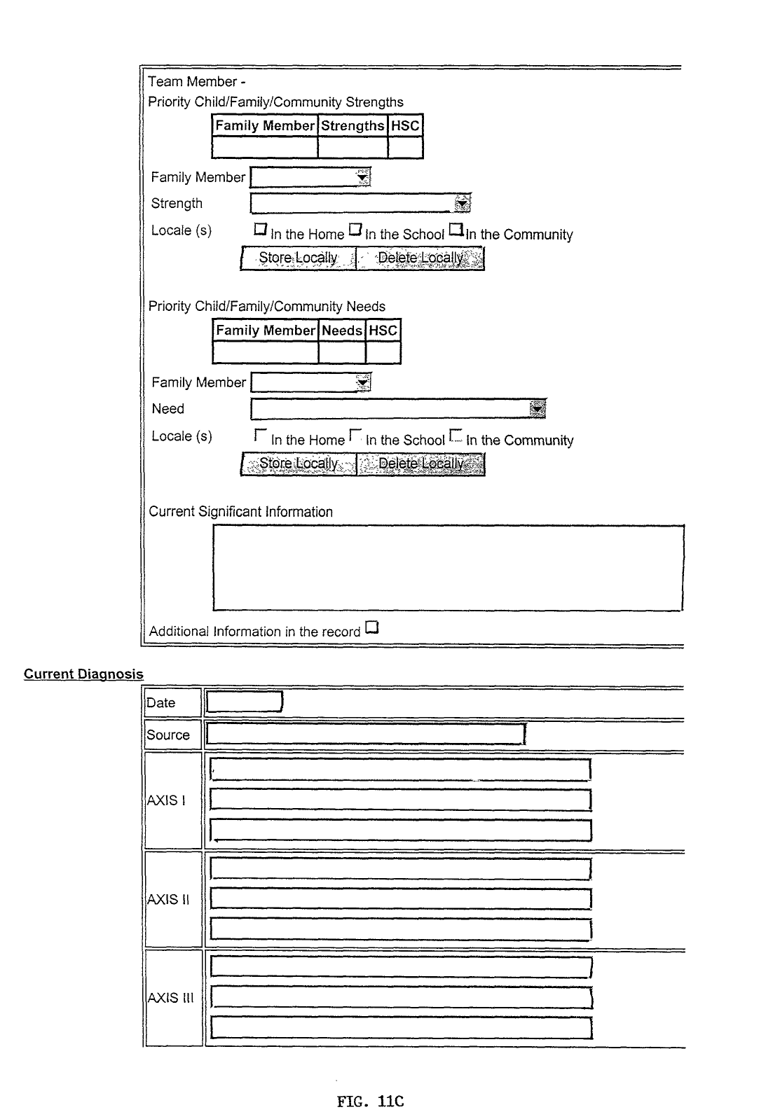

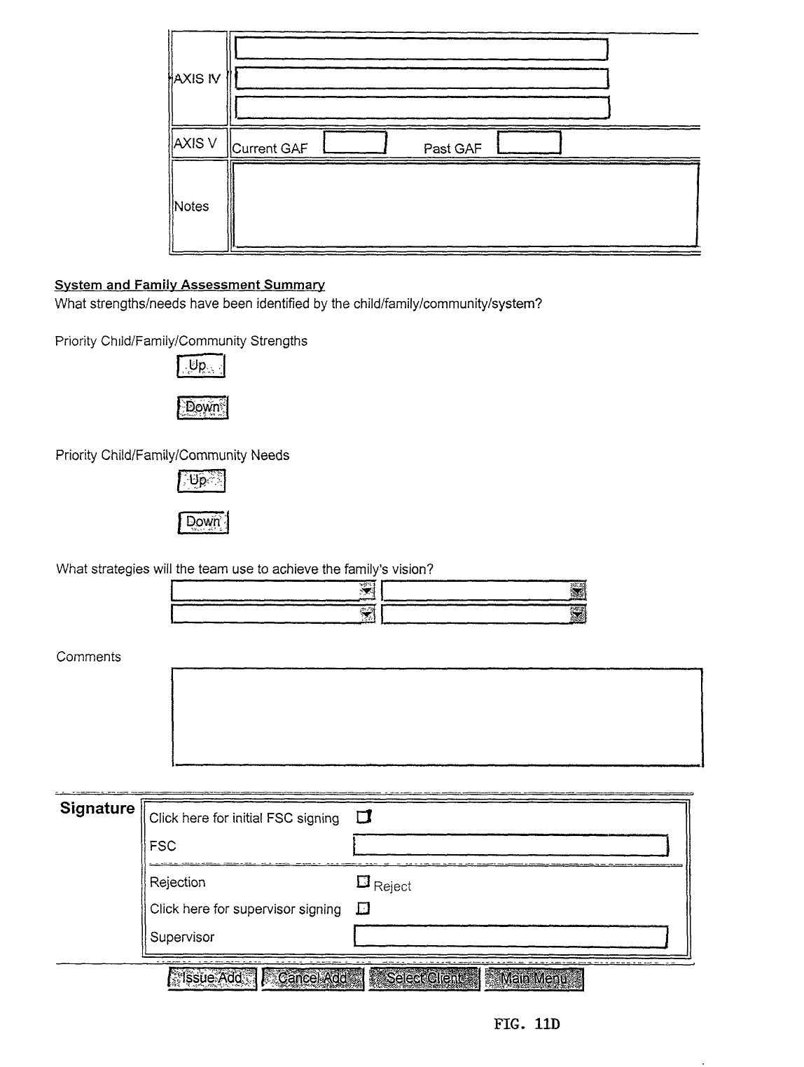

The coordinator meets with the team members to assist in identifying various strengths and needs of the client and the team. An “assessment” data entry page, as illustrated in FIGS. 11A-11D, is used to enter this information, along with other information related to the care providing process. The entered information is then used to assist in the creation of a plan of care and subsequent documents relating to the provision of care. The assessment includes current client/family information, team member information (i.e., strengths and needs), information from the diagnosis, and an assessment summary. Among other things, the assessment determines what the team's long term vision or defined objective for the client is, whether or not the client or the client's family have any significant cultural background, what the family hopes to accomplish over the next six month, what behaviors the client exhibits, and what strategies the team plans to use to achieve the team's vision or defined objective. During the assessment process, each team member states what strengths and needs they believe the client and the team members of the respective client have. Also noted is the locale (e.g., home, school, community) where the team member believe the stated strength or need exists. Information related to the strengths and needs is stored in a summary matrix within the database 20. In one embodiment, additional information may be entered about the strengths and needs (e.g., information weighting the importance of each strength or need) that is used for various statistical analyses. The assessment also requires double signature authorization before it is considered to be complete.

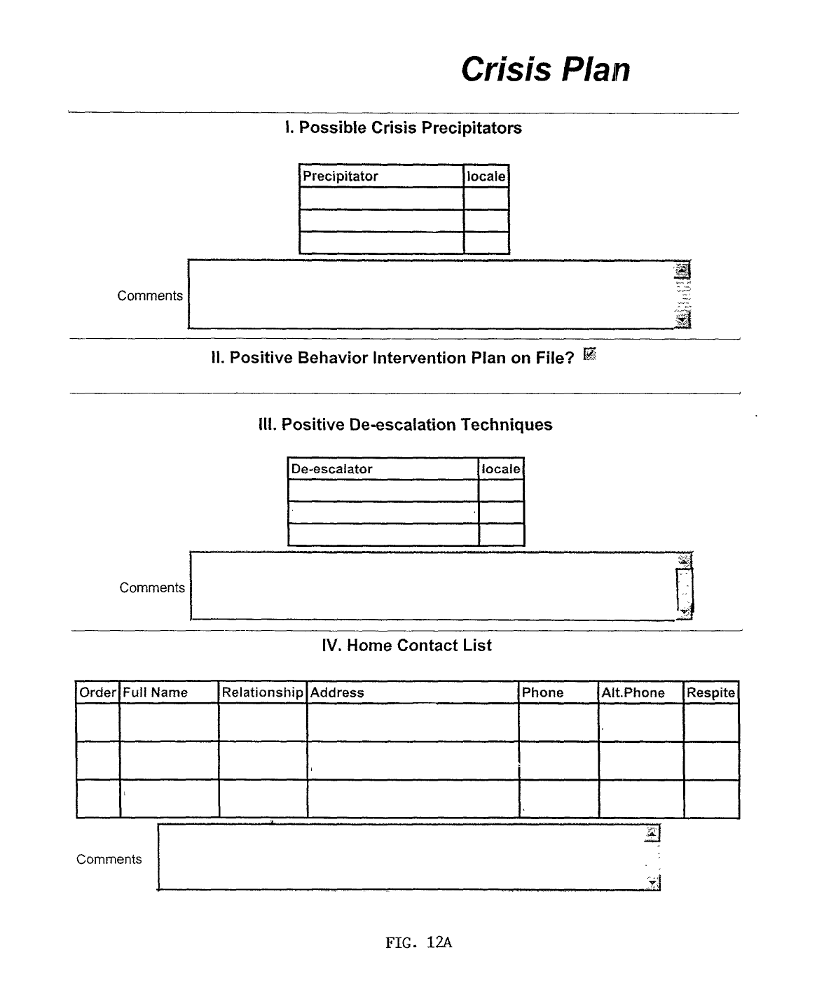

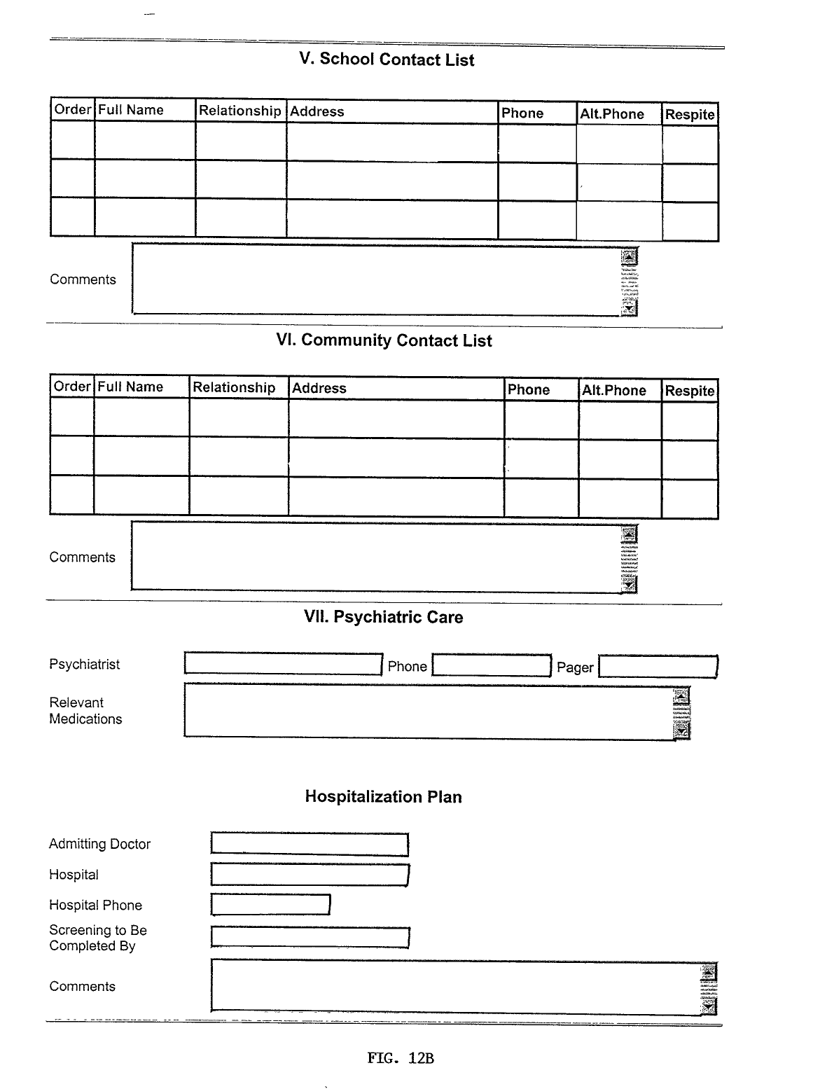

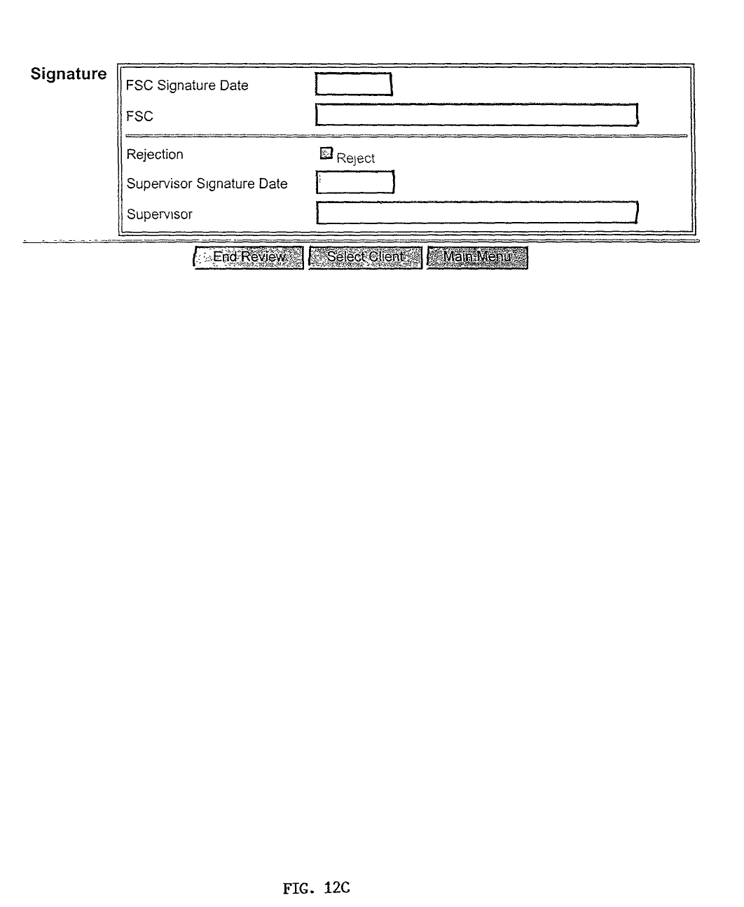

A crisis plan is developed to cover any situations that may arise that require immediate attention. There generally is a time gap between the time the client is enrolled into the system 10 and the time when a plan of care is developed for the client. The crisis plan covers this time gap by providing interventions for situations the client may be involved in including home, school, hospital, legal, community, etc. The crisis plan is typically developed by the coordinator after the assessment because at that point the coordinator has determined what strengths exists and what needs the client has. The crisis plan addresses these strengths and needs until a formalized plan of care is developed. A “crisis plan” data entry page, as illustrated in FIGS. 12A-12C, is used to input information regarding crisis precipitators, whether or not a positive behavior intervention plan is on file, de-escalation techniques, team members available to assist in intervention, and contact information for those team members. The crisis plan requires double signature authorization before it is considered complete.

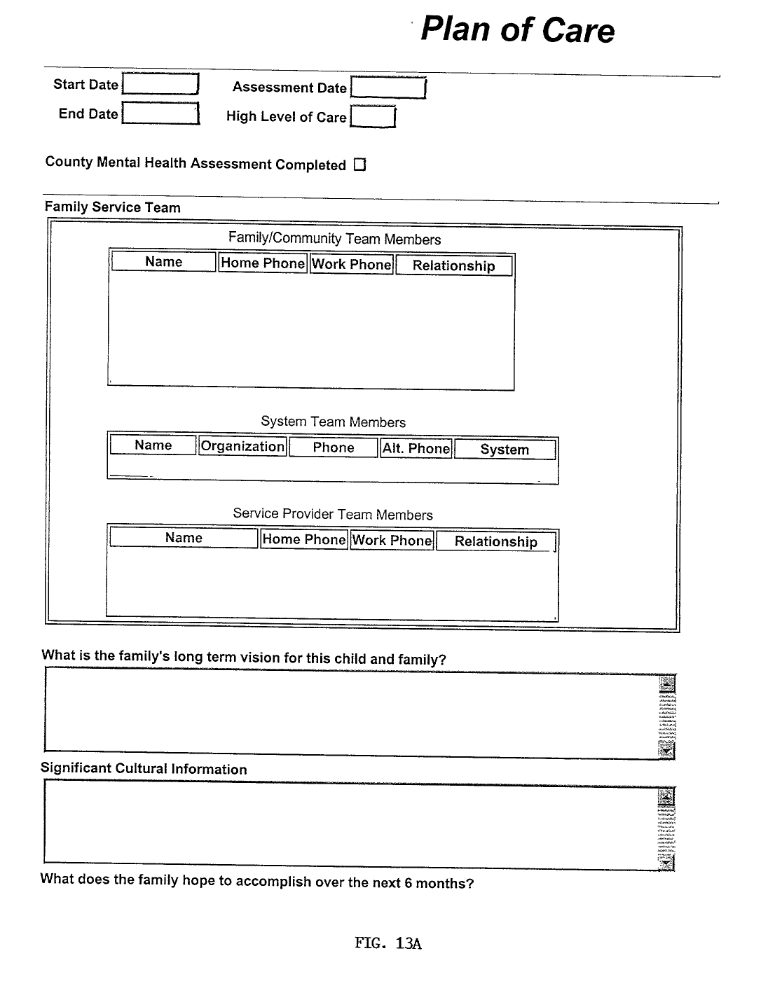

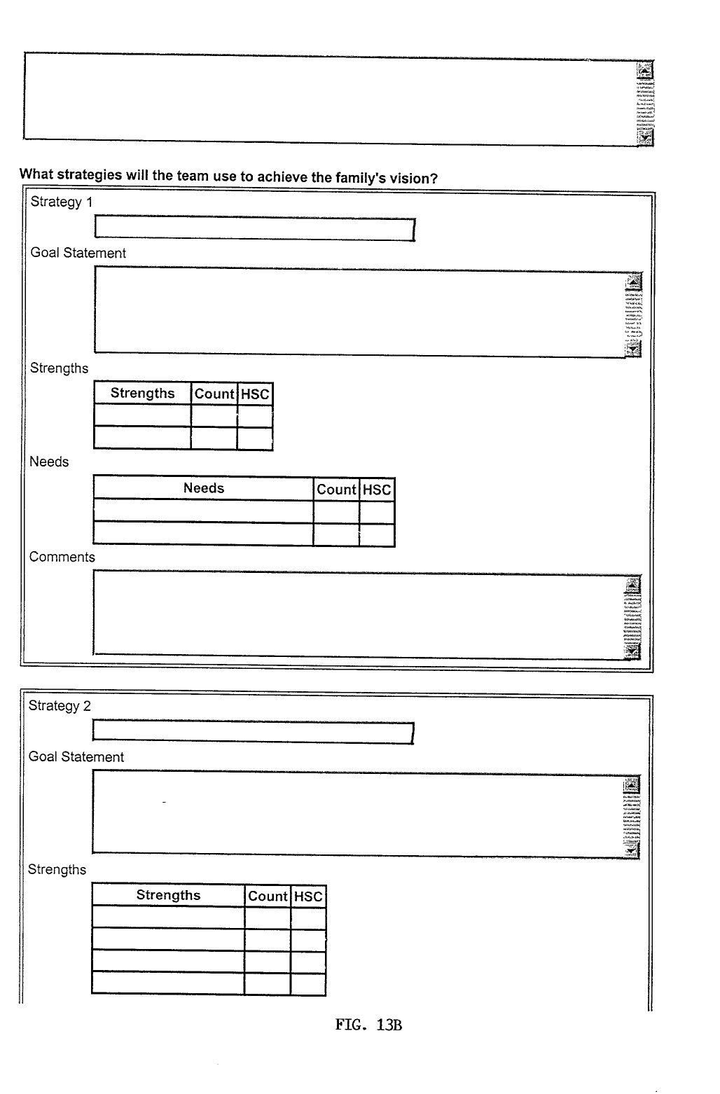

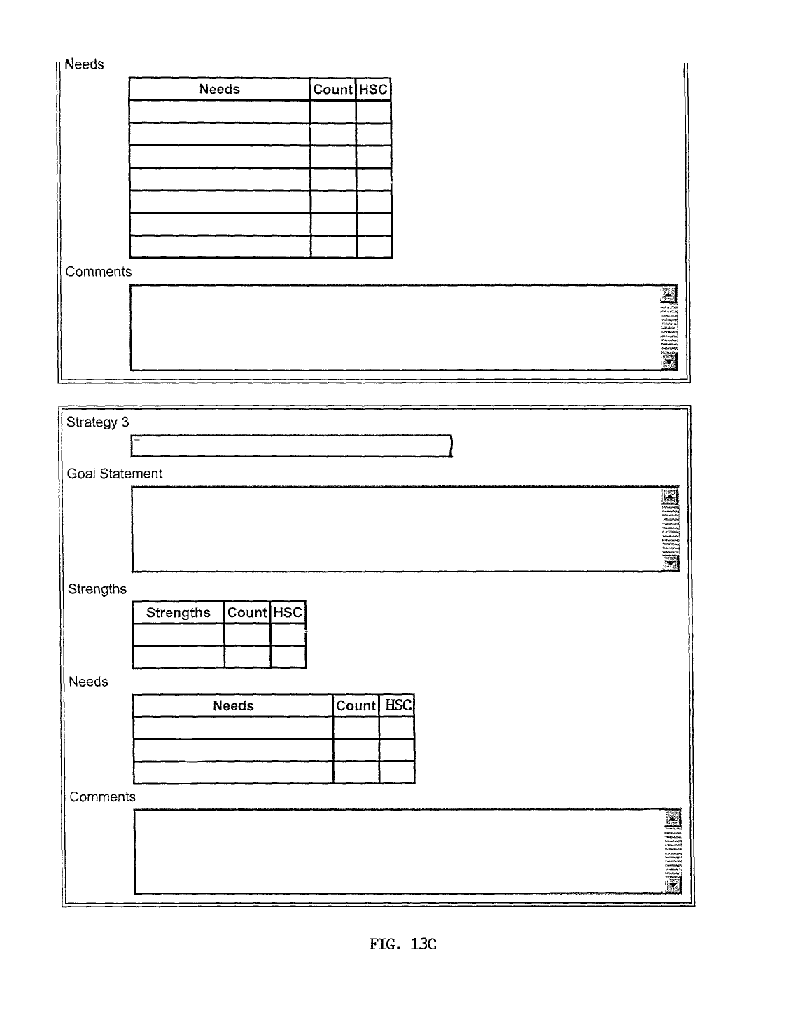

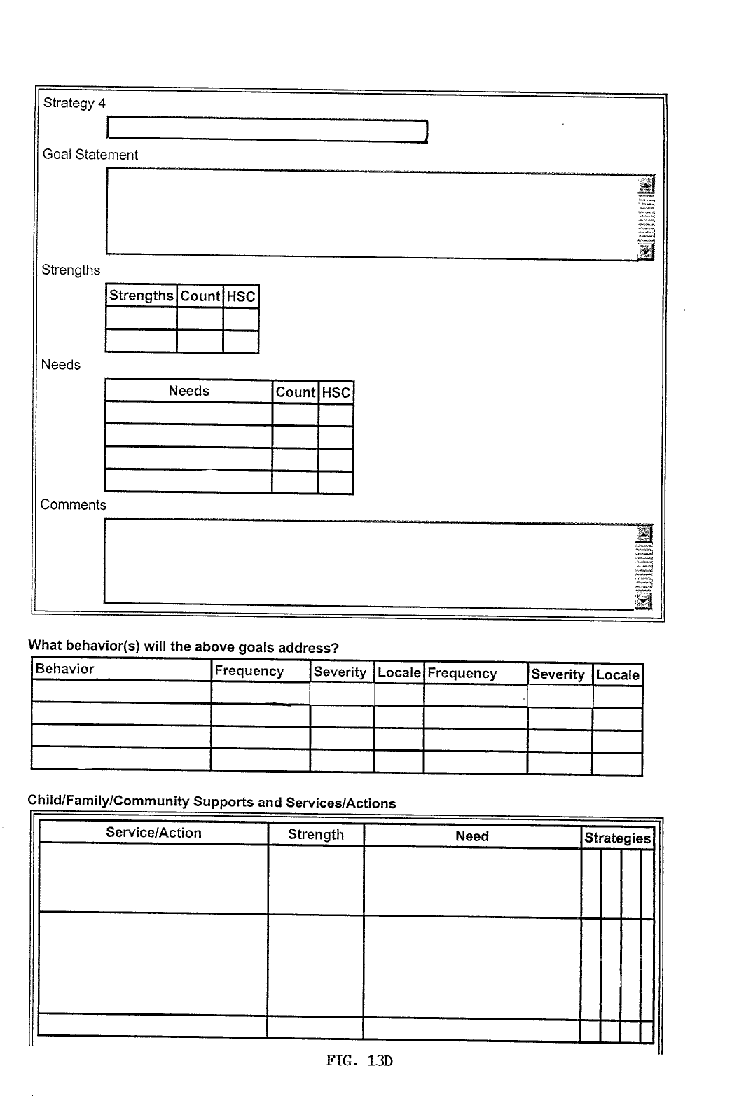

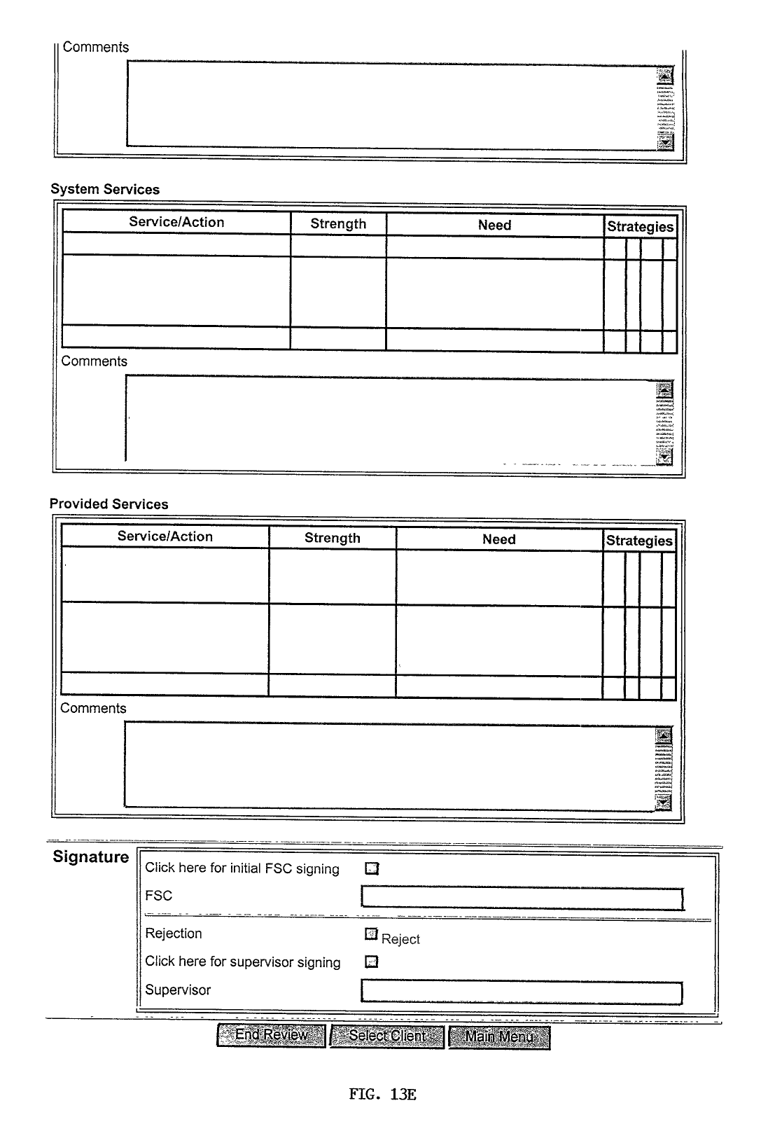

A plan of care is developed by the team members that takes into account the strengths, needs, and other factors determined during the assessment. The plan of care becomes the blueprint for a coordinated, integrated plan for the provision of care to the client. The system 10 assists the team members in the development of the plan of care by guiding them through the process. The system 10 only allows for development of a plan of care if all prior required activities have been completed, for example, the assessment and the crisis plan must be properly authorized. A plan of care is generally designed to be six months long for a client that requires a low level of care, and three months long for a client that requires a high level of care. A “plan of care” data entry page, as illustrated in FIGS. 13A- 13E, automatically calculates the start and end dates of the plan of care based on the client profile, however, these dates are adjustable. Information already in the system 10, including information from the assessment, is imported directly into the plan of care data entry page. This imported data drives the team members to use the strengths and needs of the client when developing goals for the care providing process.

For each strategy listed in the assessment, a goal statement is established and entered into the plan of care data entry page to clarify the actions needed to assist the family in achieving their vision or defined objective. A prioritized listing of all the strengths and needs of the team members determined in the assessment is also included for each strategy. As discussed above, this listing is stored in a summary matrix. The user 16 observes the strengths and needs and develops the goal statement accordingly. The prioritization of the strengths and needs allows the user 16 to determine what goal statement most effectively addresses the needs using the strengths. Checkable boxes are used to indicate when a strength is used to achieve the goal and/or when a need is addressed by the goal. Information about the strengths and the needs includes a count box that indicates the frequency of each strength or need (i.e., the number of team members that indicated that particular strength or need as one that is representative of the client and the team members), and a location box that indicates where the team members believe each strength or need exists (e.g., home, school, community). A narrative comment can also be included for each strategy to further document the use of strengths to address a particular goal, and/or address the needs, as they are met by the initiation of services and resources to meet this goal.

Information regarding the type, frequency, severity, and locale of behaviors the client exhibits is also imported into the plan of care from the assessment. The coordinator then uses this information to determine what effects each goal has on the behaviors so identified. Essentially, the coordinator predicts if the goal reduces or increase the frequency of the behavior, and by how much; and also whether or not the severity and locale of the behaviors are altered. This information is entered into the plan of care date entry page. If the goals do not properly address the indicated behaviors, the goal statements may need to be reformulated in order to have a plan of care that effectively coordinates the provision of care to the client.

After the goals have been defined and evaluated to determine if they are appropriate, the team establishes what services/actions need to take place. The plan of care data entry page includes a services/actions section for each segment of team members. Family and community support member generally determine what services/actions they can provide first because they provide free service and typically have the greatest chance of being openly accepted by the client. Team members first select services/actions from a drop down menu that includes all services/actions that the administrator has entered into the system 10, and then check-off what strengths the selected service/action builds on, what needs the service/action addresses, and what strategy the service/action is directed toward. After all strategies are effectively covered, the team can review their selections to determine if the overall plan of care is effective. Throughout the development of the plan of care, the entered information can be stored locally so that it is entered into the representative tables on the plan of care data entry page. If the entered information is determined to be correct, the finalized version can then be uploaded into the system 10. The coordinator can also continue to update the plan of care using the plan of care data entry page until the supervisor reviews and authorizes the plan of care. Once a plan of care is authorized, it can not be edited.

If a plan of care is determined to be ineffective in the provision of care to the client, the team may wish to create a new plan of care. Subsequent plans of care can be created as long as the most recent plan of care is not awaiting authorization by the supervisor. In one embodiment, the information from the most recent plan of care is imported into the plan of care data entry page for the plan of care that is being created so that the information only needs to be edited and not recreated. If additional information has been entered into the system 10 since the previous plan of care was developed (e.g., a new assessment was performed), that information is updated accordingly on the plan of care data entry page for use in development of the new plan of care.

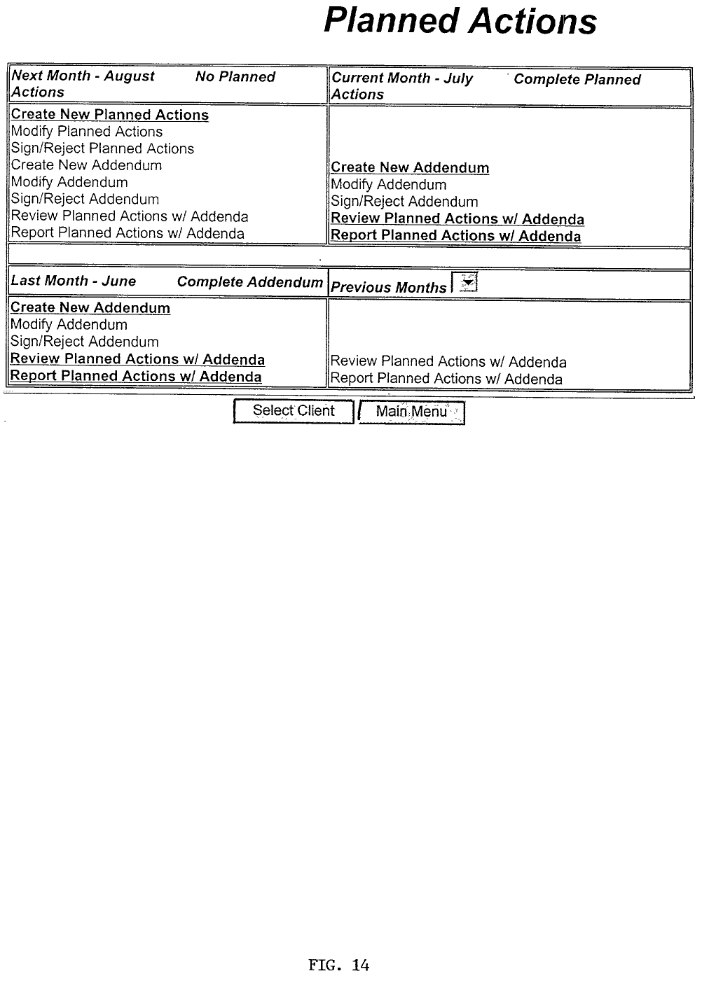

After a plan of care has been authorized, planned actions are formulated that place the plan of care into action. Planned actions are documented in the plan of care (i.e., services/actions) and authorized in the planned actions pages of the site 22. A “planned actions” data entry page essentially allows the coordinator to assign the recommended services/actions to the team members that were indicated as potential providers of such service/action. A “planned actions” timeframe selection page, as illustrated in FIG. 14, includes a listing of all available information related to planned actions for each month planned actions are need (i.e., last month, current month, next month, all previous months). If a plan of care is designed to be six months, six separate months of planned actions are developed. These shorter time frames assist the team in evaluating the plan of care to determine if it is still effective in the provision of care to the client. The users 16 can access the planned actions timeframe selection page, select what function they wish to accomplish (e.g., view planned actions that have been created, view planned actions that are waiting approval, create planned actions, authorize planned actions, etc.) and proceed from there. If a plan of care has not been authorized, or if some other required action has not been completed, the planned actions timeframe selection page indicates this status and does not allow the user 16 to proceed.

The planned actions data entry page allows the coordinator to select which service/action is to be assigned, whom it is to be assigned to, whom the recipient of the service/action is (e.g., client or other team member), and the number of units approved for the provision of the service/action. The coordinator is able to view the rate per unit for the team member selected (if that team member receives compensation for the provision of care) and thereby determine the estimated cost of providing the service/action to the client. The coordinator may also enter a goal and/or instruction for the completion of the planned action. After the planned actions have been authorized, the planned action is released to the assigned team member for execution.

A review of the planned actions for a client allows a user 16 to determine the overall cost of providing services/actions to the client. A planned actions review page includes a listing of all the signed authorization and unsigned authorization planned actions divided by the type of team member (i.e., family/community, service, system). For each planned action listed, information including a description, the provider, the recipient, the units approved, the type of units (i.e., minutes, hours, days, etc.), the total cost, and the status, is listed. A subtotal for each class of team members and an overall total for the page indicates the total cost of all services/actions for the month. Because a provider is not paid for care provided unless they are authorized to perform such provision of care, the system 10 assists in the assurance of fiscal responsibility. Additionally, having a single source for accounting allows the users 16 to better understand not only the end result of the care providing process, but also the best means for achieving that end. Cost presentations such as this demonstrate that care provided by the family/community team members is desirable because of the reduced costs. However, if the client is not progressing well with only limited assistance from the professional care providers, then the team needs to take that into consideration and adjust the plan of care accordingly.

The team meets regularly to make sure the plan of care is working or to adjust the plan as needed. The monitoring of the plan of care is an important aspect of the wraparound process to ensure the process is moving forward in an efficient manner. Evaluations are typically conducted during the implementation of the plan of care to determine which actions are effective and which actions are ineffective. The system 10 incorporates progress notes and outcome measure to assist in these evaluations.

A “progress note” data entry page allows each team member to update information regarding the planned actions which they were assigned to perform. For example, the client's Uncle Bill may be assigned an action item during the second month of the plan of care to take his nephew fishing for four hours as a change of environment that provides relaxation. If Uncle Bill took his nephew fishing for the prescribed time, this can be noted using a progress note data entry page. Any comments such as how effective the planned action appeared to be may also be noted. The progress note data entry page is accessible using a “progress note” timeframe selection page that allows the user to select the month the planned action is scheduled for. The user 16 then selects the planned action for which a progress note is needed from a listing of all planned actions for that month. Typically, information including the day the service was provided, the number of units used, travel units used, documentation units used, and use of any other authorized units is entered. When a progress note is marked as complete and uploaded into the system 10, the progress note is then no longer modifiable. The completed progress note is then used to generate invoices and bills.

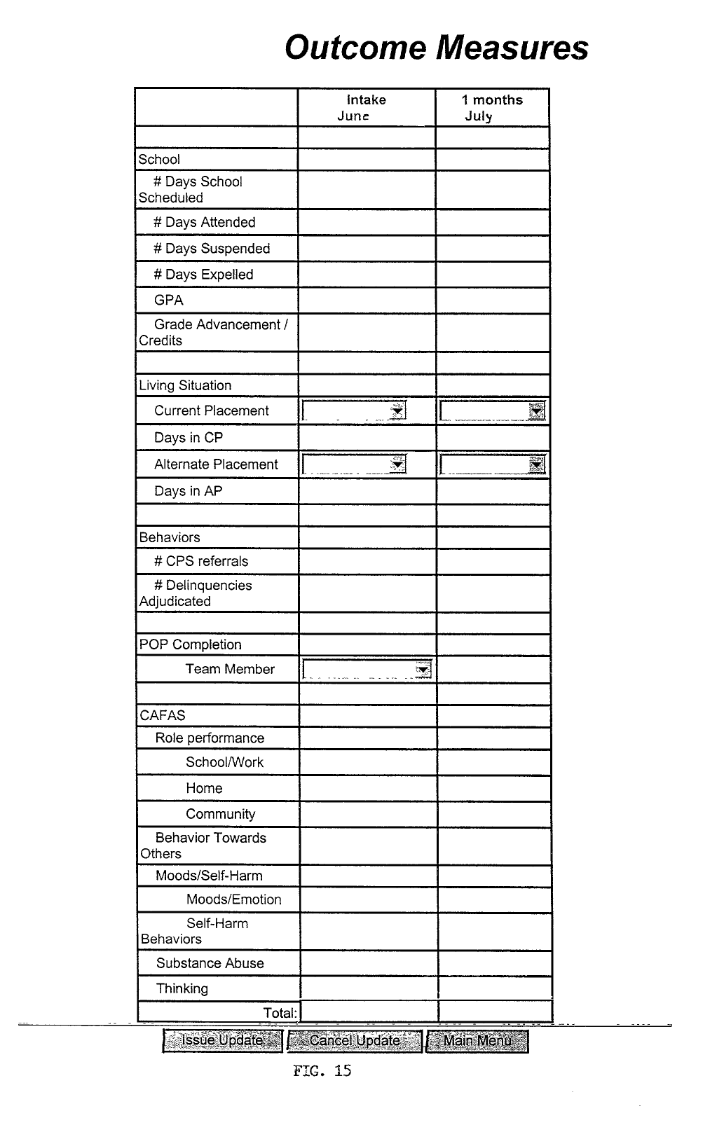

An “outcome measures” data entry page, as illustrated in FIG. 15, allows the team to track how the client is doing in various areas by tracking performance indicators. Performance indicators may be tracked for areas including school (number of days of school scheduled, number of days of school attended, number of days of school suspended, expelled, GPA, etc.), living situation, behaviors, etc. The outcome measures page indicates a value for the performance indicator at intake of the client and then every defined time duration (e.g., every month). An outcome measures data entry page is utilized to establish what performance indicators are tracked and then also to enter the actual information. The users 16 can review the information using an “outcome measures” review page.

As the client becomes more stabilized, the plan of care is adjusted to shift more and more responsibility from the professional care providers to the family/community team members. The objective is to transfer all services to family/community team members as the client needs fewer and fewer formal services. The final step of the process is the stabilization or disenrollment of the client. At this time the team does a complete review of the entire process to determine if the goals of the plan of care are met. An updated plan of care may be provided for the future that only utilizes the family/community team members. If it is determined that the client can be disenrolled from the system 10, the episode is closed thereby inactivating the client in the system 10.

An “episode close” data entry page, similar to the episode open data entry page illustrated in FIG. 8, is used to enter information regarding the status of the client at the end of the process. Information including the close data, living situation at close, legal status at close, employment status at close, and reason for termination are noted by selecting a field from a drop-down menu. A narrative comment can also be entered to discuss the episode closing information listed on the page. Any referrals of the client to other systems or care providers are also entered. Although it is desired that clients only leave the system when they successfully complete the process, some clients leave for other reasons such as moving out of the area, incarceration, lack of desire to be part of the system 10, etc. The episode close page requires double signature authorization to be completed.

Reports

The system 10 allows the users 16 to generate a number of reports. In one embodiment, there are two different types of reports, client specific reports (i.e., team reports) and analytic reports. Many of the pages of the site 22 allow the user 16 to select an action button that generates a report. Reports also can be generated using report pages accessible from the main menu. In one embodiment, the reports are formatted for viewing and/or printing (e.g., .pdf format). Although users 16 can access all information needed using the network 14, a hardcopy of a document may also be desirable for assisting the user 16 in the provision of care. Reports are also useful for functions such as compliance with various state and county regulations/rules that may require the participating agency to submit documentation of the care provided to a client, determining staff performance, fiscal analysis, etc.

Financial Aspects of the System

The system 10 is designed to ensure fiscal responsibility in the provision of individualized care. Users 16 are able to utilize financial pages of the site 22 to accomplish accounting type activities. Financial information is first input into the system 10 and then utilized by the system 10 to generate bills, invoices, and other financial documents.

A first step in using the system 10 for accounting type activities is the input of information. The system 10 keeps track of all contracts the participating organization has that relate to the provision of care. Contracts with other organizations (such as state and county agencies), care providers, insurance companies, medical benefit companies, clients, other team members, etc., are recorded and details of the contracts are utilized to calculate costs and incomes of the participating organization. For example, information entered regarding a contract for a particular care provider may include the services the care provider can provide (may be numerous services), the contract rate for each service listed, what services are covered by insurance or other reimbursement programs, any staff at the participating organization that supervises the care provider, the total number of units the care provider is authorized to perform per month/year, etc. Similarly, contract information may be entered about a county program that reimburses the participating agency for care they provide.

A “billing” page allows the user 16 to generate bills and account for receipts. When care is provided that the participating organization can be reimbursed for (whether it be from the client or from some other organization), a bill is generated that includes information about the services provided and the total cost for the services provided. Bills can be generated in billing cycles of any duration, or as needed. The user 16 can de-select particular entities that are not to be billed for a particular billing cycle. Information for billing can be directly imported from information contained on other pages. For example, if a planned action is executed that takes one hour (as indicated on a progress note), that information is noted on the billing page along with the per unit rate and the total cost of the service provided. The total cost for a particular action is added to the cost for all other actions performed resulting in the overall cost of the bill. The billing system automatically determines what services are reimbursable from insurance providers or other organizations and what services are not reimbursable by using the information input about the contracts. For example, if a service cost $100, $30 may be reimbursed by an insurance provider and the remainder may be paid for by the client. This is taken into consideration when bills are created. Of course, the billing system allows for some flexibility to adjust bills as needed.

The billing system also keeps track of all receipts received by the participating organization. When bills are sent out, the participating organization expects to be paid. When the participating organization is paid, such payment is noted in the system. If the bill is rejected, the rejection is noted and the bill can be adjusted according to the reason for rejection or resubmitted with an explanation of the reason the bill should be paid. If a bill goes unpaid for a duration of time that is greater than the time the system 10 allows, the bill is recreated and sent to the payee with a reminder that the bill needs to be paid immediately. The billing system keeps track of all credits and debits to the system 10.

Care providers that are paid for their services are able to automatically bill the participating organization using the system 10. As discussed above, when a care provider submits a progress note for a planned action that the care provider was assigned to execute, the progress note includes the amount of time actually spent on the provision of care. When the progress note is marked as completed, the information is imported into the financial pages of the system 10 and an invoice is automatically generated requesting a distribution of payment to the care provider. Just as with bills generated, invoices can be generated for a selected time frame and specific care providers can be de-selected for a specific invoice cycle. The invoices include a description of the services provided and the amount owed to the care provider. In one embodiment, the system 10 directly deposits payments for services provided based on the invoice total into the care providers bank account.

System Maintenance

The system 10 is designed to allow for customization of the individualized segment 24 due to changes in the implementation of the site 22 for the particular participating organization. The system 10 includes window labels, drop down lists, and interface titles that are largely tabled so that program code changes are not required in order to customize the information that needs to be changed. The administrator is able to add to or delete from the information contained in support tables which act as a source system for all pages of the system 10 that include automatic information generation or selection.

The administrator can access an individualized segment 24 system information page and update information including password expiration time frames (e.g., uses/days), and time frames for documentation. Dates can be set for when the assessment, crisis plan, plan of care, and planned actions are due, as well as the expectations for progress note completion. The dates set in the system information page are used to trigger the tickler list, thereby allowing the supervisors and coordinators to monitor user 16 compliance with the standard time frames.

An external names page allows the administrator to customize the language and/or look of the individualized segment 24 of the system 10. Field labels for a number of fields can be changed to allow for the use of language that is specific to the program, services, and/or community of the participating organization. For example, a participating organization may wish to call individuals being provided care patients instead of clients, this could easily be altered on the external names page.

Much of the information that is used to fill the drop-down menus is located in support tables. Some of the support tables may be provided by the system provider when the individualized segment 24 of the site 22 is setup. An example of a provided support table may include information for a diagnosis (axis I, axis II, etc.). The number and breadth of support tables provided by the system provider may depend upon the particular needs and desires of the participating organization. The administrator is able to develop additional support tables that include any and all information that the participating organization needs in the system 10 to assist in the provision of care. Support tables that are provided may also be customize to reflect the desires and needs of the participating organization.

Thus, the invention provides, among other things, a network based integrated systems of care that concentrate the best resources available to the client to assure the most effective outcome for those in need of care. Various features and advantages of the invention are set forth in the following claims.

What is claimed is:

1. A method of managing the provision of care to a client including use of a software program to ensure adherence to a wraparound process and including the involvement of a support team to provide care to the client, the support team including family members of the client, friends of the client, and other community members that know the client well, the method comprising the acts of:
inputting assessment data into a database using an assessment data entry page generated by the software program, the assessment data including strengths and needs of the client and of the support team;
displaying at least some of the assessment data on a plan of care data entry page generated by the software program; and
developing a plan of care by utilizing the plan of care data entry page as a framework for the plan of care.

2. A method as set forth in claim 1, and further comprising the act of authorizing the input of the assessment data by inputting authorization data indicating acceptance of the assessment data before the act of displaying at least some of the assessment data on the plan of care data entry page.

3. A method as set forth in claim 1 wherein the act of developing a plan of care includes inputting plan of care data into the database using the plan of care data entry page, the plan of care data including services/actions to be carried out for the provision of care to the client.

4. A method as set forth in claim 3, and further comprising the acts of:
displaying at least some of the services/actions on a planned actions data entry page generated by the software program; and
assigning planned actions to members of the support team and to professional care providers based on the services/actions displayed.

5. A method as set forth in claim 4 wherein the act of assigning planned actions includes inputting planned actions data into the database using the planned actions data entry page.

6. A method as set forth in claim 1, and further comprising the act of authorizing the input of the plan of care data by inputting authorization data indicating acceptance of the plan of care data before the act of displaying at least some of the services/actions.

7. A method as set forth in claim 1, and further comprising the act of authorizing the input of the planned actions data by inputting authorization data indicating acceptance of the planned actions data before the members of the support team members and the professional care providers provide care to the client.

8. A method as set forth in claim 1, and further comprising the acts of:
displaying at least some of the assessment data on a crisis plan data entry page generated by the software program; and
developing a crisis plan by utilizing the crisis plan data entry page as a framework for the crisis plan.

9. A method as set forth in claim 8 wherein the act of developing a crisis plan includes inputting crisis plan data into the database using the crisis plan data entry page, the crisis plan data including
crisis precipitators,
de-escalation techniques, and
team members available to assist in intervention for the client.

10. A method as set forth in claim 9, and further comprising the act of authorizing the input of crisis plan data by inputting authorization data indicating acceptance of the crisis plan data before the act of displaying at least some of the assessment data on the plan of care data entry page.

11. A method as set forth in claim 1, and further comprising the acts of:
inputting referral data representative of a potential client into the database using a referral data entry page generated by the software program;
displaying at least some of the referral data on an eligibility determination data entry page generated by the software program; and
making an eligibility determination of the potential client by utilizing the eligibility determination data entry page.

12. A method as set forth in claim 11 wherein the act of making an eligibility determination includes inputting eligibility determination data into the database using the eligibility determination page.

13. A method as set forth in claim 12, and further comprising the act of authorizing the input of eligibility determination data by inputting authorization data indicating acceptance of the eligibility determination data before the potential client becomes a client if the potential client is determined to be eligible for participation.

14. A method as set forth in claim 1, and further comprising the acts of:
inputting enrollment data into the database using a team member data entry page generated by the software program and an episode open data entry page generated by the software program, the enrollment data including team member data and episode open data; and
inputting diagnosis data into the database using a diagnosis data entry page generated by the software program.

15. A method as set forth in claim 5, and further comprising the acts of:
inputting progress note data using a progress note data entry page generated by the software program, the progress note data corresponding to the planned actions data.

16. A method as set forth in claim 1, and further comprising the act of inputting outcome measures data into the database using an outcome measures data entry page generated by the software program.

17. A method as set forth in claim 1, and further comprising the act of generating action items on a user's tickler list, wherein the action items are representative of tasks that need to be completed to allow the provision of care to progress.

18. A method as set forth in claim 1, and further comprising the act of generating reports, wherein the reports represent data input into the database.

19. A method as set forth in claim 1, and further comprising the act of ensuring fiscal responsibility in the provision of care.

20. A method as set forth in claim 19 wherein the act of ensuring fiscal responsibility includes the acts of
generating invoices based on progress note data, and
accounting for receipts.

21. A method of managing the provision of care to a client including use of a software program to ensure adherence to a wraparound process, the method comprising the acts of:
inputting data related to the provision of care to the client into a database using a first page generated by the software program; and
inputting further data related to the provision of care to the client into the database using a second page generated by the software program, wherein the software program prevents entry of the further data until the first page is authorized by at least one authorizing user.

22. A method as set forth in claim 21 wherein the data includes eligibility determination data and the further data is at least one of episode open data, team member data, diagnosis data, assessment data, crisis plan data, plan of care data, planned actions data, progress note data, outcome measures data, and episode close data.

23. A method as set forth in claim 21 wherein the data includes assessment data and the further data is at least one of crisis plan data, plan of care data, planned actions data, progress note data, outcome measures data, and episode close data.

24. A method as set forth in claim 21 wherein the data includes crisis plan data and the further data is at least one of plan of care data, planned actions data, progress note data, outcome measures data, and episode close data.

25. A method as set forth in claim 21 wherein the data includes plan of care data and the further data is at least one of planned actions data, progress note data, outcome measures data, and episode close data.

26. A method as set forth in claim 21 wherein the data includes planned actions data and the further data is at least one of progress note data, outcome measures data, and episode close data.

27. A method as set forth in claim 21 wherein the first page is authorized by inputting authorization data into the database.

28. A method of developing a plan of care for a client including use of a software program to ensure adherence to a wraparound process and including the involvement of a support team to provide care to the client, the support team including family members of the client, friends of the client, and other community members that know the client well, the method comprising the acts of:
inputting assessment data into a database using an assessment data entry page generated by the software program, the assessment data including
a defined objective for the client,
strategies for achieving the defined objective,
behaviors exhibited by the client, and
strengths and needs of the client and of the support team;
displaying at least some of the assessment data on a plan of care data entry page generated by the software program; the act of displaying including the act of displaying each of the strategies for achieving the defined objective along with a list of the strengths and needs;
developing a plan of care by utilizing the plan of care data entry page as a framework for the plan of care, the act of developing a plan of care including the acts of
analyzing the strengths and needs listed,
formulating a goal statement for each of the strategies for achieving the defined objected based on the analyzed strengths and needs, and
inputting plan of care data based on the goal statements into the database using the plan of care data entry page.

29. A method as set forth in claim 28, and further comprising the act of prioritizing the strengths and needs before the act of displaying at least some of the assessment data.

30. A method as set forth in claim 28, and further comprising the acts of:
displaying additional assessment data on the plan of care data entry page, wherein the act of displaying includes displaying each of the behaviors that the client exhibits including a frequency of the behavior, a severity of the behavior, and a locale of the behavior;
evaluating the overall effect the goal statements have on each of the behaviors;
developing expected outcomes for the client based on the act of evaluating, wherein the act of developing expected outcomes includes inputting additional plan of care data into the database using the plan of care data entry page, the additional plan of care data including an outcome frequency of the behavior, an outcome severity of the behavior, and an outcome locale of the behavior.

31. A method as set forth in claim 30 and further comprising the act of redeveloping the plan of care if the expected outcomes are not analogous to the defined objective for the client.

32. A method as set forth in claim 28 and further comprising the act of inputting additional plan of care data into the database using the plan of care data entry page, the additional plan of care data including services/actions the team members may perform to meet the goal statements for each of the strategies.

33. A network based integrated system of care comprising: a computer; and
a software program stored on the computer for
inputting assessment data into a database using an assessment data entry page generated by the software program, the assessment data including strengths and needs of the client and of the support team,
displaying at least some of the assessment data on a plan of care data entry page generated by the software program, and
developing a plan of care by utilizing the plan of care data entry page as a framework for the plan of care.
